(19) United States
(12) Patent Application Publication
(10) Pub. No.: US 2025/0223389 A1
(43) Pub. Date: Jul. 10, 2025

(54) AUTONOMOUSLY CURABLE AND FOAMABLE TWO-COMPONET ACRYLIC ADHESIVE

(71) Applicant: ZEPHYROS, INC., Romeo, MI (US)

(72) Inventors: Roland RAHME, Rhinau (FR); Eric ELKAIM, Mussig (FR)

(73) Assignee: Roland RAHME, Rhinau (FR)

(21) Appl. No.: 18/847,646

(22) PCT Filed: Mar. 15, 2023
(86) PCT No.: PCT/EP2023/056661

§ 371 Date: Sep. 16, 2024

(30) Foreign Application Priority Data
Mar. 17, 2022 (EP) 22162704.5

(51) Int. Cl. C08F 220/20; C08J 9/08; C09J 4/00

(52) U.S. Cl. CPC C08F 220/20; C08J 9/08; C09J 4/00; C08J 2201/022; C08J 2203/02; C08J 2207/02; C08J 2333/00

(57) ABSTRACT

The invention relates to an autonomously curable and foamable two-component acrylic adhesive that upon combining the two components with one another spontaneously foams and cures thereby forming a cured foamed acrylic adhesive. The cured foamed acrylic adhesive may have utility as structural adhesive, sealant, noise dampening material and the like. The cured foamed acrylic adhesive is particularly useful for structural reinforcement within cavities of structural elements, e.g. of automotive vehicles, aircrafts, railway carriers, or other means of transportation.

The invention relates to an autonomously curable and foamable two-component acrylic adhesive that upon combining the two components with one another spontaneously foams and cures thereby forming a cured foamed acrylic adhesive. The cured foamed acrylic adhesive may have utility as structural adhesive, sealant, noise dampening material and the like. The cured foamed acrylic adhesive is particularly useful for structural reinforcement within cavities of structural elements, e.g. of automotive vehicles, aircrafts, railway carriers, or other means of transportation.

Adhesives can be divided into cured materials and curable materials. Pressure sensitive adhesives are representative cured materials that exist in a single state in which they are tacky and adhesive as such. In contrast, curable adhesives exist in two different states, an initial uncured state and a subsequent cured state. Such materials develop their adhesiveness by curing that is typically induced by a suitable stimulus (heat, UV light, oxygen, mixing two components with one another, and the like). As far as acrylic adhesives are concerned, reference is made to e.g. U.S. 2006 024521, U.S. 2010 218892, U.S. 2010 286331, U.S. 2011 083804, U.S. 2011 143061, U.S. 2012 171915, U.S. 2013 292054, U.S. 2014 053976, U.S. 2014 329959, U.S. 2015 151522, U.S. 2017 306191, U.S. 2018 179422, U.S. 2019 276715, U.S. 2020 102483, and U.S. 2020 216717.

Adhesives can likewise be divided into foamed materials and foamable materials. Foamed pressure sensitive adhesives are representative foamed materials that exist in a single state in which they are foamed as such. In contrast, foamable adhesives exist in two different states, an initial unfoamed state and a subsequent foamed state. Such foamable materials typically contain blowing agents (foaming agents) that upon heat activation release a gas. Various blowing agents are known, which can be divided into chemical blowing agent and physical blowing agents.

Foamed pressure sensitive acrylic adhesives can be produced by chemical foaming methods in which a foaming agent is foamed in an acrylic solution prior to curing followed by its curing, or by mechanical foaming methods in which an inert gas such as nitrogen gas is dispersed and mixed into an acrylic solution prior to curing followed by its curing. Acrylic adhesives that may contain blowing agents (foaming agents) are known from e.g. U.S. 2003 013493, U.S. 2008 238137, U.S. 2009 169852, and U.S. 2013 165610.

JP 4 589 692 B2 relates to a two liquid type acrylic adhesive that contains (A) a polymeric monomer, (B) an organic peroxide, (C) a vanadium compound, and (D) an acidic phosphoric acid compound, wherein 80 mass % or more of (A) is a (meth)acrylate having a specified molecular structure and molecular weight.

U.S. Pat. No. 5,945,461 A relates to foamed in place polymer compositions that are made from monomerin-polymer solutions containing free radical polymerization catalysts and foaming agents.

U.S. Pat. No. 4,119,583 A relates to foamed articles that are made by causing the cross-linking of a thermosetting resin, preferably a polyester resin, concurrently with the production of carbon dioxide by the reaction of a carbonate with an inorganic acid. The carbonate is mixed with the resin and the acid then folded in in a progressively accelerated blending operation, whereupon carbon dioxide is generated to foam the resin, the carbonate, acid and setting time of the resin being selected to obtain an appropriate match between the progress of the foaming operation and the setting of the foam.

WO 2020/178105 A1 relates to a two-component structural adhesive, i.e. to a two-component system of a first component and a second component spatially separated from one another, wherein the reaction of the first component and the second component after mixing results in a structural adhesive. The first component comprises at least four of a (meth)acrylic acid, a C1-6-alkyl (meth)acrylate, a cycloalkyl (meth)acrylate, a hydroxy-C1-6-alkyl (meth)acrylate, and/or a glycolether (meth)acrylate. The second component comprises a peroxide polymerization initiator.

The adhesives of the prior art are not satisfactory in every respect. There is a demand for improved curable adhesives that are autonomously foamable upon demand without requiring heat.

It is an object of the invention to provide adhesives that have advantages compared to the prior rt.

This object has been achieved by the subject-matter of the patent claims.

A first aspect of the invention relates to an autonomously curable and foamable two-component acrylic adhesive of
(i) a first component comprising
   a first constituent of a binary chemical foaming agent; and
   a first curable ingredient which comprises or essentially consists of one or more acrylic monomers and/or one or more acrylate functionalized (pre-)polymers; preferably one, two, three, four, five, six, seven or more acrylic monomers independently of one another selected from the group consisting of monomers (a) to (u) defined below; and
(ii) a second component comprising
   a second constituent of the binary chemical foaming agent which releases gas when being mixed with the first constituent of the binary chemical foaming agent;
   optionally, a second curable ingredient which comprises or essentially consists of one or more acrylic monomers and/or one or more acrylate functionalized (pre-)polymers; preferably one, two, three, four, five, six, seven or more acrylic monomers independently of one another selected from the group consisting of monomers (a) to (u) defined below; and
   a polymerization initiator;
      wherein the first component and the second component are spatially separated from one another; and wherein mixing the first component and the second component with one another induces the formation of a cured foamed acrylic adhesive.

It has been surprisingly found that based on acrylic chemistry two-component adhesives may be provided that upon mixing the two components with one another spontaneously cure and foam. Curing reaction and foaming reaction at least partially proceed simultaneously and it has been surprisingly found that kinetics of these parallel reactions can be synchronized so that a stable foam is formed. The foam is particularly useful for various industrial applications including but not limited to filling cavities of structural elements, e.g. of automotive vehicles, aircrafts, railway carriers, or other means of transportation.

The invention relates to an autonomously curable and foamable two-component acrylic adhesive. For the purpose of the specification, the expression “autonomously curable and foamable” means that the two-component acrylic adhesive according to the invention contains all ingredients that are necessary to spontaneously activate a curing process and a foaming process when the two components are mixed with one another under ambient conditions (23° C., 50% relative humidity). No external ingredient needs to be added, neither needs the mixture to be heated to elevated temperature.

The invention provides fast-curing two-component acrylic adhesives that are preferably toughened. The acrylic adhesive preferably provide primerless adhesion to most metals, thermoplastics and composites. The ratio between open time and time to handling strength has been optimized versus other two-component acrylic adhesives on the market thereby minimizing cycle times. The two-component acrylic adhesives according to the invention preferably do not boil at higher bonding gaps—an ideal solution for repair or backfill of large composite structures. Due to their low odor, the two-component acrylic adhesives according to the invention can be used in metal-working shops and other places where typical odor such as distinctive MMA odor is restricted. The two-component acrylic adhesives according to the invention are preferably thixotropic also creating value due to fast-mixing and rapid extrusion without sacrificing non-sag properties.

The two-component acrylic adhesive according to the invention comprises a first component and a second component. While it is principally possible that the two-component acrylic adhesive comprises further components in addition to the first and second component, preferably the two-component acrylic adhesive essentially consists of the first component and the second component.

In its non-activated state (neither cured nor foamed), the first component and the second component are spatially separated from one another. In this non-activated state, the two-component acrylic adhesive may be stored typically having a shelf-life of at least several months. For example, the two-component acrylic adhesive may be made commercially available in a cartridge comprising two separate chambers where the first component is contained in a first chamber of the cartridge and the second component is contained in a second chamber of the cartridge.

For applicability by means of a cartridge and other purposes, the first components and the second component of the acrylate adhesive according to the invention are preferably semisolid, preferably a paste. Viscosity may vary. In preferred embodiments, the first components and the second component of the acrylate adhesive according to the invention are pumpable with a viscosity that is low enough in order to allow e.g. flowing into a hole. Once polymerization and curing has commenced, viscosity will of course increase.

In its activated state, the first component and the second component are mixed with one another thereby inducing chemical reaction that finally results in formation of a cured and foamed acrylic adhesive. For example, when being contained in spatially separated chambers of a cartridge, the first component may be mixed with the second component when exiting the cartridge e.g. through a nozzle or die for application to a substrate. As the first component and the second component are mixed with one another, the ingredients thereof can chemically react with one another thereby curing and foaming the material under ambient conditions, i.e. not requiring external heat.

Typically, curing of the material is an exothermic reaction so that the material may heat during the curing process. At ambient conditions, the temperature of the material may increase slowly until it reaches a higher temperature of e.g. about 40° C. At higher temperatures, curing may be accelerated and the temperature of the mixture may increase faster, e.g. 2 to 3° C. per second, until it reaches a maximum curing temperature. The maximum curing temperature may depend on the quantity of material used. For example, thick adhesive joints may reach maximum curing temperatures of more than about 90° C. In contrast, thin adhesive joints may reach maximum curing temperatures below 90° C.

Foaming of the material is preferably not temperature dependent and therefore also occurs independently of the curing temperature. This may allow the material to foam in the same way at lower temperatures as well as at elevated temperatures. Preferably, the foaming process can be controlled by variation of the first constituent and/or the second constituent of the binary chemical foaming agent. For example, the content of the first constituent of the binary chemical foaming agent may be variated, as well as the nature and/or average particle size of the second constituent of the binary chemical foaming agent.

As chemical reaction takes some time that highly depends upon the ingredients of the two-component acrylic adhesive, it is typically distinguished between open time and curing time. The open time is usually regarded as the time window immediately after mixing of the two components during which the acrylic adhesive may be applied to a substrate, flow and may still be deformed. Open time may be regarded as a lag time before curing has started or at least has proceeded to a certain extent at which applying and processing the acrylic adhesive becomes difficult because of advancing polymerization, curing and foaming. The curing time is usually regarded as the time window following the open time until the acrylic adhesive has completely reacted, i.e. until polymerization and curing reactions have been completed. The open time and the curing time may independently of one another last from a few minutes to several hours and there is no clear-cut between open time and curing time; transition may be smooth.

Foaming typically occurs during the open time, i.e. at least a portion of the overall foaming is achieved before expiry of the open time. When the acrylic adhesive is applied to a first substrate that is located in some distance to a second substrate and when the acrylic adhesive due to foaming expands its volume and thereby reaches the second substrate, it is still reactive enough to adhere to the surface of the second substrate. In preferred embodiments, foaming continues after the open time has expired. In other preferred embodiments, foaming is completed within the open time.

For certain industrial applications it can be desirable to specifically adjust open time and curing time. In certain embodiments it can be desirable to have an open time within the range of from 1 to 30 minutes, preferably 2 to 20 minutes or even 2 to 10 minutes, and subsequently to have a curing time that is as short as possible. When using the two-component acrylic adhesive e.g. on an assembly line, this will provide sufficient time for applying the acrylic adhesive to the desired substrate, but also will allow for further processing after a short period or even immediately thereafter, as polymerization, curing and foaming proceeds quickly. Thus, polymerization, curing and foaming will not significantly delay operation on the assembly line.

In preferred embodiments, the acrylic adhesive according to the invention is an adhesive that can be used to produce a load-bearing joint, preferably an acrylic structural adhesive. Preferably, the acrylic adhesive according to the invention is useful for engineering applications where joints typically have lap shear strengths of at least 1 MPa and, more normally, at least 10 MPa. Acrylic structural adhesives are used extensively in automotive and aircraft industry for bonding metal-to-metal, metal-to-composite and composite-to-composite parts. The two-component acrylic adhesive according to the invention is preferably a structural adhesive, i.e. an adhesive with a strength that is critical to the success of the assembly. Structural adhesives typically have high shear strength (typically in excess of 6.9 MPa (1000 psi) according to ASTM D1002 adhesive lap joint shear testing) and resistance to most common operating environments.

In other preferred embodiments, the acrylic adhesive according to the invention has sealant properties and is thus useful as a sealant. For these purposes, the acrylic adhesive can be formulated as a very flexible, soft adhesive.

A skilled person recognizes that in its non-activated state (neither cured nor foamed), certain ingredients of the two-component acrylic adhesive can be present in either component without inducing premature chemical reaction. Thus, unless these components comprise reactive functional groups, it makes no big difference whether these ingredients are contained in the first component or in the second component or in both the first and the second component. This is particularly the case for toughening agents and impact modifiers.

However, especially when the polymerization initiator is comparatively reactive, the polymerizable monomers of the two-component acrylic adhesive on the one hand and the polymerization initiator of the two-component acrylic adhesive on the other hand should be stored separate of one another. The same applies to the first constituent and the second constituent of the binary chemical foaming agent. For these reasons, the first component of the two-component acrylic adhesive comprises the monomers and the first constituent of the binary chemical foaming agent; whereas the second component comprises the polymerization initiator and the second constituent of the binary chemical foaming agent. It can be investigated by routine tests whether a given polymerization initiator is too reactive for a given curable ingredient such that is must be spatially separated in order to avoid premature polymerization and curing. When it is too reactive, the second curable ingredient is omitted and the total content of acrylic monomers and/or acrylic functionalized (pre-)polymers is contained in the first curable ingredient of the first component.

In preferred embodiments, especially when the first component has a significantly greater volume and/or weight than the second component, e.g. 10:1, the total content of all acrylic monomers and/or acrylic modified (pre-)polymers is preferably contained in the first component, namely the first curable ingredient thereof, whereas the second component, i.e. the second curable ingredient thereof, preferably contains neither acrylic monomers nor acrylic modified (pre-)polymers.

In other preferred embodiments, especially when the excess of volume/and or weight of the first component relative to the second component is less pronounced, e.g. 4:1, 2:1 or even 1:1, the total content of all acrylic monomers and/or acrylic modified (pre-)polymers is preferably divided into two portions, whereas a first portion is contained in the first component, namely the first curable ingredient thereof, and a second portion is contained in the second component, namely the second curable ingredient thereof. As individual reactivity of acrylic monomers and/or acrylic modified (pre-)polymers with a given polymerization initiator can be different, the more reactive acrylic monomers and/or acrylic modified (pre-)polymers are then preferably contained in the first curable ingredient but not the second cur-able ingredient, whereas the less reactive acrylic monomers and/or acrylic modified (pre-)polymers are preferably contained in the second curable ingredient and optionally also in the first curable ingredient.

Unless expressly stated otherwise, all percentages are weight percentages and are relative to the total weight of the two-component acrylic adhesive, i.e. the overall weight of the first and second component.

Unless expressly stated otherwise, “(meth)” within chemical nomenclature of acrylic acid and acrylic acid derivatives such as acrylic acid esters (i.e. acrylates) means either absence or presence of “meth”, i.e. either acrylic acid and the corresponding derivatives of acrylic acid, or methacrylic acid and the corresponding derivatives of methacrylic acid. In other words, e.g. “(meth)acrylic acid” means “acrylic acid or methacrylic acid”, and likewise “benzyl (meth)acrylate” means “benzyl acrylate or benzyl methacrylate” (i.e. acrylic acid benzyl ester or methacrylic acid benzyl ester).

For the purpose of the specification, a toughening agent increases the ability of the acrylic adhesive to absorb energy and plastically deform without fracture. Typical toughening agents are rubbers (elastomers) that can be interspersed as nanoparticles within a polymer matrix to increase the mechanical robustness, or toughness, of the material. Toughening agents are known to the skilled person (see e.g. Bucknall C. B. (1977) Toughened Plastics, Springer; Keskkula H., Paul D. R. (1994) Toughening agents for engineering polymers. In: Collyer A. A. (eds) Rubber Toughened Engineering Plastics. Springer; Arends Ch. (1996) Polymer Toughening, Marcel Dekker).

For the purpose of the specification, an impact modifier increases the durability of the acrylic adhesive. Impact modifiers are known to the skilled person (see e.g. Berzins A. P. Impact Modifiers, Chapter 8 in Lutz J. T., Grossmann R. F. Polymer Modifiers and Adhesives (2001), Marcel Dekker).

The two-component acrylic adhesive according to the invention comprises a binary chemical foaming agent which releases gas when a first constituent is mixed with a second constituent. As the acrylic adhesive is a two-component system, the first constituent and the second constituent can be conveniently separated from one another in the first component and the second component, respectively, thereby avoiding premature activation of the foaming process.

Binary chemical foaming agents are known in the art and are also referred to effervescent bases. Binary chemical foaming agents typically comprise a constituent that is capable of releasing a gas and a constituent that induces the gas release. A very well-known binary chemical foaming agent is composed of citric acid (acidic constituent) and sodium hydrogen carbonate (gas-evolving constituent) which releases carbon dioxide when both constituents come into contact with one another. This foaming process releases water as a byproduct which has an autocatalytic function.

Preferably, the foaming process of the binary chemical foaming agent according to the invention does not release water as a byproduct.

Preferably, the first constituent or the second constituent of the binary chemical foaming agent comprises or essentially consists of an acid, and the other of the first constituent and the second constituent comprises or essentially consists of a metal carbonate or metal hydrogen carbonate.

Preferably, the first constituent comprises or essentially consists of the acid, and the second constituent comprises or essentially consists of the metal carbonate or metal hydrogen carbonate.

Preferably, the metal carbonate or metal hydrogen carbonate is selected from the group consisting of calcium carbonate, magnesium carbonate, zinc carbonate, sodium carbonate, sodium hydrogencarbonate, potassium carbonate, potassium hydrogencarbonate, and mixtures thereof; preferably calcium carbonate.

In preferred embodiments, the acid has a pKA value of at most 5.0, preferably at most 4.5, more preferably at most 4.0, still more preferably at most 3.5, yet more preferably at most 3.0, even more preferably at most 2.5, most preferably at most 2.0.

In preferred embodiments, the acid is a mineral acid; preferably selected from the group consisting of hydrochloric acid, hydrobromic acid, hydroiodic acid, sulfuric acid, sulfurous acid, nitric acid, nitrous acid, perchloric acid, boric acid, phosphoric acid, and mixtures thereof; more preferably selected from the group consisting of sulfuric acid, phosphoric acid, and mixtures thereof; most preferably phosphoric acid.

In other preferred embodiments, the acid is an organic acid; preferably an organic sulfuric acid or an organic sulfonic acid.

Preferably, the first constituent of the binary chemical foaming agent, preferably the acid, has a content of
at least 1.5 wt.-%, preferably at least 2.0 wt.-%, more preferably at least 2.5 wt.-%, still more preferably at least 3.0 wt.-%, yet more preferably at least 3.5 wt.-%, even more preferably at least 4.0 wt.-%, most preferably at least 4.5 wt.-%, and in particular at least 5.0 wt.-%; and/or
at most 25 wt.-%, preferably at most 22.5 wt.-%, more preferably at most 20 wt.-%, still more preferably at most 17.5 wt.-%, yet more preferably at most 15 wt.-%, even more preferably at most 12.5 wt.-%, most preferably at most 10 wt.-%, and in particular at most 7.5 wt.-%;
   in each case relative to the total weight of the first component.

In preferred embodiments, especially when the first component has a significantly greater volume and/or weight than the second component, e.g. 10:1, the second constituent of the binary chemical foaming agent, preferably the metal carbonate or metal hydrogencarbonate, has a content of
at least 10 wt.-%, preferably at least 15 wt.-%, more preferably at least 20 wt.-%, still more preferably at least 25 wt.-%, yet more preferably at least 30 wt.-%, even more preferably at least 35 wt.-%, most preferably at least 40 wt.-%, and in particular at least 45 wt.-%; and/or
at most 90 wt.-%, preferably at most 85 wt.-%, more preferably at most 80 wt.-%, still more preferably at most 75 wt.-%, yet more preferably at most 70 wt.-%, even more preferably at most 65 wt.-%, most preferably at most 60 wt.-%, and in particular at most 55 wt.-%;
   in each case relative to the total weight of the second component.

In other preferred embodiments, especially when the excess of volume/and or weight of the first component relative to the second component is less pronounced, e.g. 4:1, 2:1 or even 1:1, the second constituent of the binary chemical foaming agent, preferably the metal carbonate or metal hydrogencar bonate, has a content of
at least 2.5 wt.-%, preferably at least 5.0 wt.-%, more preferably at least 7.5 wt.-%, still more pref-erably at least 10 wt.-%, yet more preferably at least 12.5 wt.-%, even more preferably at least 15 wt.-%, most preferably at least 17.5 wt.-%, and in particular at least 20 wt.-%; and/or
at most 60 wt.-%, preferably at most 55 wt.-%, more preferably at most 50 wt.-%, still more prefer-ably at most 45 wt.-%, yet more preferably at most 40 wt.-%, even more preferably at most 35 wt.-%, most preferably at most 30 wt.-%, and in particular at most 25 wt.-%; in
   each case relative to the total weight of the second component.

Preferably, particles within the second constituent of the binary chemical foaming agent have an average particle size of at least 10 nm, preferably at least 20 nm, more preferably at least 30 nm, still more preferably at least 40 nm, yet more preferably at least 50 nm.

Preferably, particles within the second constituent of the binary chemical foaming agent have an average particle size of at least 0.01 μm, preferably at least 0.05 μm, more preferably at least 0.1 μm, still more preferably at least 0.5 μm.

Preferably, particles within the second constituent of the binary chemical foaming agent have an average particle size of at least 1.0 μm, preferably at least 2.0 μm, more preferably at least 4.0 μm, still more preferably at least 6.0 μm, yet more preferably at least 10 μm, even more preferably at least 15 μm.

Preferably, particles within the second constituent of the binary chemical foaming agent have an average particle size of at most 200 μm, preferably at most 150 μm, more preferably at most 100 μm, still more preferably at most 75 μm, yet more preferably at most 50 μm, even more preferably at most 30 μm.

Preferably, particles within the second constituent of the binary chemical foaming agent have an average particle size of at most 50 μm, preferably at most 25 μm, more preferably at most 10 μm, still more preferably at most 5.0 μm.

Preferably, particles within the second constituent of the binary chemical foaming agent have an average particle size of at most 500 nm, preferably at most 300 nm, more preferably at most 250 nm, still more preferably at most 200 nm, yet more preferably at most 150 nm.

Preferably, particles within the second constituent of the binary chemical foaming agent have an average particle size within the range of from 0.01 to 500 μm, preferably from 0.05 to 250 μm, more preferably from 0.1 to 100 μm, still more preferably from 0.5 to 50 μm.

Preferably, particles within the second constituent of the binary chemical foaming agent have an average particle size within the range of from 1.0 to 200 μm, preferably from 2.0 to 150 μm, more preferably from 4.0 to 100 μm, still more preferably from 6.0 to 75 μm, yet more prefer-ably from 10 to 50 μm, even more preferably from 15 to 30 μm.

Preferably, particles within the second constituent of the binary chemical foaming agent have an average particle size within the range of from 0.01 to 50 μm, preferably from 0.05 to 25 μm, more preferably from 0.1 to 10 μm, still more preferably from 0.5 to 5.0 μm.

Preferably, particles within the second constituent of the binary chemical foaming agent have an average particle size within the range of from 10 to 500 nm, preferably from 20 to 300 nm, more preferably from 30 to 250 nm, still more preferably from 40 to 200 nm, yet more preferably from 50 to 150 nm.

For the purpose of the specification, the average particle size is the number average particle size determined by dynamic image analysis according to ISO 13322-1 in the dry state. The average particle size in the nanometer scale can for example be determined by means of a Nano Measurer 1.2.0. The average particle size in the micrometer scale can for example be determined by means of a CAMSIZER X2. The skilled person knows how to calibrate the measuring device and suitable calibration samples are commercially available.

Preferably, the first and/or the optionally present second curable ingredient independently of one another comprises or essentially consists of one, two, three, four, five, six, seven or more acrylic monomers independently of one another selected from the group consisting of
(a) monomers of formula (a) H₂C═CR—C(═O)—O-C₂₋₁₄-alkyl-OH;
(b) monomers of formula (b) H₂C═CR—C(═O)—OH;
(c) monomers of formula (c) H₂C═CR—C(═O)—O-C₂₋₁₈-alkyl;
(d) monomers of formula (d) H₂C═CR—C(═O)—O-C₁₋₆-alkyl-(hetero-)aryl, wherein the (hetero-)aryl moiety is optionally substituted with one, two or three substituents independently of one another selected from -C₁₋₆-alkyl;
(e) monomers of formula (e) H₂C═CR—C(═O)—O-C₂₋₁₄-alkyl-O—P(═O)(OH)_{z};
(f) monomers of formula (f) H₂C═CR—C(═O)—O-C₂₋₁₄ alkyl-O—C(═O)-C₁₋₆-alkyl-C(═O)-C₁₋₆-alkyl;
(g) monomers of formula (g) H₂C═CR—C(═O)—[O—CH₂—CH₂]ₙ—OH, wherein index n is an integer within the range of from 1 to 12;
(h) monomers of formula (h) H₂C═CR—C(═O)—[O—CH₂-CH₂]ₙ—O-C₁₋₆-alkyl, wherein index n is an integer within the range of from 1 to 12;
(i) monomers of formula (i) H₂C═CR—C(═O)—[O—CH₂—CH(CH₃)]ₙ—OH, wherein index n is an integer within the range of from 1 to 12;
(j) monomers of formula G) H₂C═CR—C(═O)—[O—CH₂—CH(CH₃)]ₙ—O-C₁₋₆-alkyl, wherein index n is an integer within the range of from 1 to 12;
(k) monomers of formula (k) H2C═CR—C(═O)—O-C₂₋₄(hetero-)cycloalkyl, wherein the (hetero-)cyclo-alkyl moiety is optionally substituted with one, two or three substituents independently of one an-other selected from -C₁₋₆-alkyl;
(l) monomers of formula (1) H₂C═CR—C(═O)—O-C₁₋₆-alkyl-C₂₋₁₄(hetero-)cycloalkyl, wherein the (het-ero-)cycloalkyl moiety is optionally substituted with one, two or three substituents independently of one another selected from -C₁₋₆-alkyl;
(m) monomers of formula (m) H₂C═CR—C(═O)—O-C₇₋₁₄-bi- or tri-cycloalkyl, wherein the bi- or tri-cycloalkyl moiety is optionally substituted with one, two or three substituents independently of one another selected from -C₁₋₆-alkyl;
(n) monomers of formula (n) H₂C═CR—C(═O)—O-C₁₋₆-alkyl-C₇₋₁₄-bi- or tri-cycloalkyl, wherein the bi- or tri-cycloalkyl moiety is optionally substituted with one, two or three substituents independently of one another selected from -C₁₋₆-alkyl;
(o) monomers of formula (o) H₂C═CR—C(═O)—O-(hetero-)aryl, wherein the (hetero-)aryl moiety is optionally substituted with one, two or three substituents independently of one another selected from
-C₁₋₆-alkyl;
(p) monomers of formula (p) H₂C═CR—C(═O)—O-C₂₋₁₄-alkyl-O—C(═O)—CR═CH₂;
(q) monomers of formula (q) H₂C═CR—C(═O)—[O—CH₂—CH₂]ₙ—O—C(═O)—CR═CH₂; wherein index n is an integer within the range of from 1 to 12;
(r) monomers of formula (r) H₂C═CR—C(═O)—O—C₇₋₁₄-bi- or tri-cycloalkyl-O—C(═O)—CR═CH₂, wherein the bi- or tri-cycloalkyl moiety is optionally substituted with one, two or three substituents independently of one another selected from -C₁₋₆-alkyl;
(s) monomers of formula(s) H₂C═CR—C(═O)—O—C₁₋₆-alkyl-C₇₋₁₄-bi- or tri-cycloalkyl-C₁₋₆-alkyl-O—C(═O)—CR═CH₂, wherein the bi- or tri-cycloalkyl moiety is optionally substituted with one, two or three substituents independently of one another selected from -C₁₋₆-alkyl;
(t) monomers of formula (t) H₂C═CR—C(═O)—[O—CH₂—CH₂]n-O-phenyl-CR′R″-phenyl-O—[CHz-CHz-O]ₙ—C(═O)—CR═CH₂, wherein R′ and R″ independently of one another mean —H or -C₁₋₆-alkyl; wherein index n is an integer within the range of from 1 to 16; and
(u) monomers of formula (u) [H₂C═CR—C(═O)—O-C₁₋₆-alkyl]₃-C₂₋₁₄(hetero-)cycloalkyl, wherein the (hetero-)cycloalkyl moiety is optionally substituted with one, two or three substituents ═0;
   wherein in each case R independently of one another means —H or —CH₃.

In preferred embodiments, the first component, namely the first ingredient thereof, but not the second component, i.e. not the second ingredient thereof, of the acrylic adhesive according to the invention contains one or more acrylic monomers, preferably independently of one another selected from the group consisting of monomers (a) to (u); and/or one or more acrylate functionalized (pre-)polymers.

In other preferred embodiments, the first component, namely the first ingredient thereof, as well as the second component, namely the second ingredient thereof, of the acrylic adhesive according to the invention contains one or more acrylic monomers, preferably independently of one another selected from the group consisting of monomers (a) to (u); and/or one or more acrylate functionalized (pre-)polymers. As the second component contains a polymerization initiator, according to these embodiments premature polymerization and curing of the second component is to be avoided. This can be achieved by using polymerization initiators that have high activation temperatures with regard to homolysis, i.e. that are stable at room temperature, such as cumyl hydroperoxide. In view of its toxicity, however, cumyl hydroperoxide is preferably not contained in the acrylic adhesive according to the invention. These stable polymerization initiators are then preferably activated at room temperature by means of curatives (curing accelerators) that are contained in the first component. When the second component contains one or more acrylic monomers and/or one or more acrylate functionalized (pre-)polymers, the polymerization initiator that is also contained in the second component preferably has an activation temperature with respect to homolysis above 50° C., preferably at least 55° C., more preferably at least 60° C., still more preferably at least 65° C., yet more preferably at least 70° C. Activation temperatures of various polymerization initiators are known to the skilled person and listed in the scientific or commer-cial literature (e.g. for the Peroxan® series available from Pergan Marshall LLC and the Perkadox® series available from Nouryon Functional Chemicals B.V.).

In preferred embodiments, the two-component acrylic adhesive according to the invention comprises not more than 5.0 wt.-% methyl methacrylate, relative to the total weight of the two-component acrylic adhesive, or no methyl methacrylate at all.

In other preferred embodiments, the two-component acrylic adhesive according to the invention comprises methyl methacrylate; preferably more than 5.0 wt.-%, relative to the total weight of the two-component acrylic adhesive.

In preferred embodiments, the two-component acrylic adhesive according to the invention like-wise comprises not more than 5.0 wt.-% methyl acrylate, relative to the total weight of the two-compo-nent acrylic adhesive, or no methyl acrylate at all.

In other preferred embodiments, the two-component acrylic adhesive according to the invention likewise comprises methyl acrylate; preferably more than 5.0 wt.-% methyl acrylate, relative to the total weight of the two-component acrylic adhesive.

In case that the two-component acrylic adhesive does comprise methyl methacrylate and/or me-thyl acrylate, due to their nature these monomers are contained in the first component, i.e. as part of the first and/or the optionally present second curable ingredient independently of one another.

In preferred embodiments, the two-component acrylic adhesive according to the invention independently of one another comprises not more than 4.0 wt.-%, preferably not more than 3.0 wt.-%, more preferably not more than 2.0 wt.-%, still more preferably not more than 1.5 wt.-%, yet more pref-erably not more than 1.0 wt.-%, even more preferably not more than 0.5 wt.-%, most preferably not more than 0.1 wt.-% methyl acrylate and/or methyl acrylate, in each case relative to the total weight of the two-component acrylic adhesive, and in particular no methyl acrylate and no methyl acrylate at all.

The first component comprises a first and/or the optionally present second curable ingredient independently of one another which in tum comprises or essentially consists of certain monomers, which preferably are independently of one another selected from the group consisting of monomers (a) through (u).

Besides the first and/or the optionally present second curable ingredient independently of one another and the first constituent of the binary chemical foaming agent, the first component preferably contains additional ingredients such as tougheners and/or impact modifiers, fillers, epoxy resins, polyurethanes, isocyanates, (meth)acrylate esters and other ingredients that are conventionally contained in two-component acrylic adhesives. Thus, any content or percentage referring to the first component is related to the total amount of the first and/or the optionally present second curable ingredient independently of one another and the additional ingredients that are contained in the first component.

For the purpose of the specification, the first and/or the optionally present second curable ingredient independently of one another principally encompasses any ethylenically unsaturated species that is capable of undergoing radical polymerization reaction, especially acrylic monomers such as acrylic acid, methacrylic acid, acrylic acid esters and methacrylic acid esters, and/or acrylate functionalized (pre-)polymers. Thus, any content or percentage referring to the first and/or the optionally present sec-ond curable ingredient independently of one another is related to the total amount of these monomers contained in the mixture. Tougheners or impact modifiers, however, are not to be regarded as monomers in the meaning of the invention, even if they contain residual ethylenically unsaturated groups (e.g. acrylic or methacrylic functional groups) that in principle are still capable of undergoing radical polymerization and being incorporated into a propagating polymer chain, respectively.

Preferably, “acrylic monomers” in the meaning of the invention, i.e. monomers encompassed by the terms “first curable ingredient” and “second curable ingredient”, have a molecular weight of not more than 600 g/mol, preferably not more than 550 g/mol. Thus, in a preferred embodiment, any theoretically radically polymerizable species having a molecular weight of more than 600 g/mol, preferably more than 550 g/mol, is not to be regarded as part of the acrylic monomers of the first and/or the option-ally present second curable ingredient. Preferably, any monomer in the meaning of the invention is either (meth)acrylic acid or a (meth)acrylic acid ester, preferably satisfying the above requirement with respect to maximum molecular weight.

Preferably, the expression “acrylate functionalized (pre-)polymers” according to the invention encompasses prepolymers as well as polymers. Typically, the “acrylate functionalized (pre-)polymers” are distinguished from the “acrylic monomers” in that they comprise at least 2 repetition units, preferably at least 3 repetition units, i.e. are oligomerized or polymerized to a certain extent already. Preferably, the “acrylate functionalized (pre-)polymers” according to the invention have a weight average molecular weight above 600 g/mol.

Preferably, “prepolymers” in the meaning of the invention are defined in accordance with the Gold Book of IUPAC, i.e. as polymers or oligomers the molecules of which are capable of entering, through reactive groups, into further polymerization and thereby contributing more than one structural unit to at least one type of chain of the final polymer (see https:/lgoldbook.iupac.orglterms/view/PT07163).

Preferably, “polymers” in the meaning of the invention are also defined in accordance with the Gold Book of IUPAC, i.e. as substances composed of macromolecules (see https:/lgoldbook.iupac.orglterms/view/P04735).

Preferably, the total content of all acrylic monomers and/or acrylate functionalized (pre-)poly-mers that are contained in the first and/or the optionally present second curable ingredient independently of one another amounts to
at least 5.0 wt.-%, preferably at least 10 wt.-%, more preferably at least 15 wt.-%, still more prefer-ably at least 20 wt.-%, yet more preferably at least 25 wt.-%, even more preferably at least 30 wt.-%, most preferably at least 35 wt.-%, and in particular at least 40 wt.-%; and/or
at most 95 wt.-%, preferably at most 90 wt.-%, more preferably at most 85 wt.-%, still more prefer-ably at most 80 wt.-%, yet more preferably at most 75 wt.-%, even more preferably at most 70 wt.-%, most preferably at most 65 wt.-%, and in particular at most 60 wt.-%;
   in each case relative to the total weight of the component in which they are contained.

Preferably, the first and/or the optionally present second curable ingredient independently of one another comprises or essentially consists of a monomer of formula (b), a monomer of formula (d), and a monomer of formula (e); optionally together with a monomer of formula (a).

Preferably, the first and/or the optionally present second curable ingredient independently of one another comprises or essentially consists of a monomer (b) and at least one monomer selected from the group consisting of (a), (c), (d), (e), (f), (g), (h), (i), (j), (k), (l), (m), (n), (o), (p), (q), (r), (s), (t), and (u).

Preferably, the first and/or the optionally present second curable ingredient independently of one another comprises or essentially consists of a monomer (d) and at least one monomer selected from the group consisting of (a), (b), (c), (e), (f), (g), (h), (i), (j), (k), (l), (m), (n), (o), (p), (q), (r), (s), (t), and (u).

Preferably, the first and/or the optionally present second curable ingredient independently of one another comprises or essentially consists of a monomer (b), a monomer (d) and at least one monomer selected from the group consisting of (a), (c), (e), (f), (g), (h), (i), (j), (k), (l), (m), (n), (o), (p), (q), (r), (s), (t), and (u).

Preferably, the first and/or the optionally present second curable ingredient independently of one another comprises or essentially consists of a monomer (a) and two or more monomers inde-pendently of one another selected from the group consisting of (b), (c), (d), (e), (f), (g), (h), (i), (j), (k), (l), (m), (n), (o), (p), (q), (r), (s), and (t).

Preferably, the first and/or the optionally present second curable ingredient independently of one another comprises or essentially consists of a monomer (a) and two or more monomers inde-pendently of one another selected from the group consisting of (b), (c), (d), (e), (f), (h), (i), (k), (l), (m), (p), (q), (s), (t), and (u).

Preferably, the first and/or the optionally present second curable ingredient independently of one another comprises or essentially consists of a monomer (a) and two or more monomers inde-pendently of one another selected from the group consisting of (b), (d), (e), (f), (h), (k), (m), (p), (q), (s), (t), and (u).

Preferably, the first and/or the optionally present second curable ingredient independently of one another comprises or essentially consists of a monomer (a) and two or more monomers independently of one another selected from the group consisting of (b), (d), (e), (f), (h), (k), (m), (p), (q), (s), and (t).

Preferably, the first and/or the optionally present second curable ingredient independently of one another comprises or essentially consists of a monomer of formula (a), a monomer of formula (b), and a monomer of formula (d).

Preferably, the first and/or the optionally present second curable ingredient independently of one another comprises or essentially consists of a monomer of formula (a) and at least three monomers independently of one another selected from the group consisting of (a), (b), (c), (d), (e), (f), (g), (h), (i), (j), (k), (l), (m), (n), (o), (p), (q), (r), (s), (t), and (u).

Preferably, the first and/or the optionally present second curable ingredient independently of one another comprises or essentially consists of a monomer of formula (b), a monomer of formula (d), and a monomer of formula (e); optionally together with a monomer of formula (a).

Preferably, the first and/or the optionally present second curable ingredient independently of one another comprises or essentially consists of a monomer of formula (a) and at least four monomers independently of one another selected from the group consisting of (a), (b), (c), (d), (e), (f), (g), (h), (i), G), (k), (l), (m), (n), (o), (p), (q), (r), (s), (t), and (u).

Preferably, the first and/or the optionally present second curable ingredient independently of one another comprises or essentially consists of a monomer of formula (b), a monomer of formula (d), and a monomer of formula (e), and a monomer of formula (h); optionally together with a monomer of formula (a).

Preferably, the first and/or the optionally present second curable ingredient independently of one another comprises or essentially consists of a monomer of formula (b), a monomer of formula (d), and a monomer of formula (e), and a monomer of formula (m); optionally together with a monomer of formula (a).

Preferably, the first and/or the optionally present second curable ingredient independently of one another comprises or essentially consists of a monomer of formula (b), a monomer of formula (d), and a monomer of formula (e), and a monomer of formula (k); optionally together with a monomer of formula (a).

Preferably, the first and/or the optionally present second curable ingredient independently of one another comprises or essentially consists of a monomer of formula (a) and at least five monomers independently of one another selected from the group consisting of (a), (b), (c), (d), (e), (f), (g), (h), (i), (j), (k), (l), (m), (n), (o), (p), (q), (r), (s), (t), and (u).

Preferably, the first and/or the optionally present second curable ingredient independently of one another comprises or essentially consists of a monomer of formula (b), a monomer of formula (d), and a monomer of formula (e), a monomer of formula (h), and a monomer of formula (k); optionally together with a monomer of formula (a).

Preferably, the first and/or the optionally present second curable ingredient independently of one another comprises or essentially consists of a monomer of formula (b), a monomer of formula (d), and a monomer of formula (e), a monomer of formula (h), and a monomer of formula (m); optionally together with a monomer of formula (a).

Preferably, the first and/or the optionally present second curable ingredient independently of one another comprises or essentially consists of a monomer of formula (a) and at least six monomers independently of one another selected from the group consisting of (a), (b), (c), (d), (e), (f), (g), (h), (i), G), (k), (l), (m), (n), (o), (p), (q), (r), (s), (t), and (u).

Preferably, the first and/or the optionally present second curable ingredient independently of one another comprises or essentially consists of a monomer of formula (b), a monomer of formula (d), and a monomer of formula (e), a monomer of formula (h), a monomer of formula (k), and a monomer of formula (m); optionally together with a monomer of formula (a).

Preferably, the monomer of formula (a) is selected from the group consisting of hydroxyethyl (meth)acrylate, hydroxypropyl (meth)acrylate, and hydroxybutyl (meth)acrylate; preferably hydroxy-ethyl acrylate, hydroxyethyl methacrylate, hydroxypropyl acrylate, or hydroxypropyl methacrylate.

Preferably, the monomer of formula (a) has a content of
at least 3.0 wt.-%, preferably at least 3.5 wt.-%, more preferably at least 4.0 wt.-%, still more pref-erably at least 4.5 wt.-%, yet more preferably at least 5.0 wt.-%, even more preferably at least 5.5 wt.-%, most preferably at least 6.0 wt.-%, and in particular at least 6.5 wt.-%; and/or
at most 35 wt.-%, preferably at most 32 wt.-%, more preferably at most 29 wt.-%, still more prefer-ably at most 26 wt.-%, yet more preferably at most 23 wt.-%, even more preferably at most 20 wt.-%, most preferably at most 17 wt.-%, and in particular at most 14 wt.-%;
   in each case relative to the total weight of the component in which it is contained.

Preferably, the monomer of formula (b) is (meth)acrylic acid; preferably methacrylic acid.

Preferably, the monomer of formula (b) has a content of
at least 1.6 wt.-%, preferably at least 2.0 wt.-%, more preferably at least 2.4 wt.-%, still more preferably at least 2.8 wt.-%, yet more preferably at least 3.2 wt.-%, even more preferably at least 3.6 wt.-%, most preferably at least 4.0 wt.-%, and in particular at least 4.4 wt.-%; and/or
at most 10.6 wt.-%, preferably at most 10.2 wt.-%, more preferably at most 9.8 wt.-%, still more preferably at most 9.4 wt.-%, yet more preferably at most 9.0 wt.-%, even more preferably at most 8.6 wt.-%, most preferably at most 8.2 wt.-%, and in particular at most 7.8 wt.-%;
   in each case relative to the total weight of the component in which it is contained.

Preferably, the monomer of formula (c) is H₂C═CR—C(═O)—O-C₃₋₁₆-alkyl, more preferably H₂C═CR—C(═O)—O-C₄₋₁₄-alkyl.

Preferably, the monomer of formula (c) is selected from the group consisting of n-propyl (meth)acrylate, iso-propyl (meth)acrylate, n-butyl (meth)acrylate, tert-butyl (meth)acrylate, sec-butyl (meth)acrylate, iso-butyl (meth)acrylate, 2-ethylhexyl (meth)acrylate, octyl (meth)acrylate, iso-octyl (meth)acrylate, decyl (meth)acrylate, iso-decyl (meth)acrylate, undecyl (meth)acrylate, dodecyl (meth)acrylate, tridecyl (meth)acrylate, tetradecyl (meth)acrylate, hexadecyl (meth)acrylate, and octadecyl (meth)acylate; preferably tert-butyl acrylate, tert-butyl methacrylate, iso-butyl acrylate, iso-butyl methacrylate, 2-ethylhexyl acrylate, 2-ethylhexyl methacrylate, dodecyl acrylate, dodecyl methacrylate, tetradecyl acrylate, or tetradecyl methacrylate.

Preferably, the monomer of formula (c) has a content of
at least 2.0 wt.-%, preferably at least 4.0 wt.-%, more preferably at least 6.0 wt.-%, still more preferably at least 8.0 wt.-%, yet more preferably at least 10 wt.-%, even more preferably at least 12 wt.-
%, most preferably at least 14 wt.-%, and in particular at least 16 wt.-%; and/or
at most 36 wt.-%, preferably at most 34 wt.-%, more preferably at most 32 wt.-%, still more preferably at most 30 wt.-%, yet more preferably at most 28 wt.-%, even more preferably at most 26 wt.-%, most preferably at most 24 wt.-%, and in particular at most 22 wt.-%;
   in each case relative to the total weight of the component in which it is contained.

Preferably, the monomer of formula (d) is selected from the group consisting of benzyl (meth)acrylate, 2-phenylethyl (meth)acrylate, 3-phenylpropyl (meth)acrylate, and furfuryl (meth)acrylate; preferably benzyl acrylate or benzyl methacrylate.

Preferably, the monomer of formula (d) has a content of
at least 2.0 wt.-%, preferably at least 3.0 wt.-%, more preferably at least 4.0 wt.-%, still more preferably at least 5.0 wt.-%, yet more preferably at least 6.0 wt.-%, even more preferably at least 7.0 wt.-%, most preferably at least 8.0 wt.-%, and in particular at least 9.0 wt.-%; and/or
at most 24 wt.-%, preferably at most 22 wt.-%, more preferably at most 20 wt.-%, still more preferably at most 18 wt.-%, yet more preferably at most 16 wt.-%, even more preferably at most 14 wt.-%, most preferably at most 12 wt.-%, and in particular at most 10 wt.-%;
   in each case relative to the total weight of the component in which it is contained.

Preferably, the monomer of formula (e) is selected from the group consisting of 2-(meth)acryloyloxyethyl phosphate, 4-(meth)acryloyloxybutyl phosphate, and 10-(meth)acryloyloxydecyl phosphate; preferably 2-acryloyloxyethyl phosphate or 2-methacryloyloxyethyl phosphate.

Preferably, the monomer of formula (e) has a content of
at least 1.5 wt.-%, preferably at least 1.7 wt.-%, more preferably at least 1.9 wt.-%, still more preferably at least 2.1 wt.-%, yet more preferably at least 2.3 wt.-%, even more preferably at least 2.5 wt.-%, most preferably at least 2.7 wt.-%, and in particular at least 2.9 wt.-%; and/or
at most 10.5 wt.-%, preferably at most 10 wt.-%, more preferably at most 9.5 wt.-%, still more preferably at most 9.0 wt.-%, yet more preferably at most 8.5 wt.-%, even more preferably at most 8.0 wt.-%, most preferably at most 7.5 wt.-%, and in particular at most 7.0 wt.-%;
   in each case relative to the total weight of the component in which it is contained.

Preferably, the monomer of formula (f) is selected from the group consisting of 2-(meth)acryloyloxyethyl acetoacetate, 3-(meth)acryloyloxypropyl acetoacetate, 3-(meth)acryloyloxy-2,2-dimethylpropyl acetoacetate, and 3-(meth)acryloyloxy-2,2,4-trimethylpentyl acetoacetate; preferably 2-acryloyloxyethyl acetoacetate or 2-methacryloyloxyethyl acetoacetate.

Preferably, the monomer of formula (f) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the monomer of formula (g) is hydroxy polyethylene glycol (meth)acrylate, wherein index n is 1, 2, 3, 4, 5, 6, 7, 8, 9, 10 or 11; preferably hydroxy diethylene glycol methacrylate; wherein index n indicates the average value of the repeating unit.

Preferably, the monomer of formula (g) has a content of
at least 1.2 wt.-%, preferably at least 1.5 wt.-%, more preferably at least 1.8 wt.-%, still more preferably at least 2.1 wt.-%, yet more preferably at least 2.4 wt.-%, even more preferably at least 2.7 wt.-%, most preferably at least 3.0 wt.-%, and in particular at least 3.3 wt.-%; and/or
at most 19 wt.-%, preferably at most 18 wt.-%, more preferably at most 17 wt.-%, still more prefer-ably at most 16 wt.-%, yet more preferably at most 15 wt.-%, even more preferably at most 14 wt.-%, most preferably at most 13 wt.-%, and in particular at most 12 wt.-%;
   in each case relative to the total weight of the component in which it is contained.

Preferably, the monomer of formula (h) is selected from the group consisting of methyl poly-ethylene glycol (meth) acrylate, wherein index n is 1, 2, 3, 4 or 11, ethyl polyethylene glycol (meth)acry-late, wherein index n is 1, 2, 3, 4, 5, 6, 7, 8, 9, 10 or 11, propyl polyethylene glycol (meth)acrylate, wherein index n is 1, 2, 3, 4, 5, 6, 7, 8, 9, 10 or 11, and butyl polyethylene glycol (meth)acrylate, wherein index n is 1, 2, 3, 4, 5, 6, 7, 8, 9, 10 or 11; preferably methyl polyethylene glycol methacrylate, wherein index n is 11, methyl polyethylene glycol acrylate, wherein index n is 11, butyl diethylene glycol acry-late, or butyl diethylene glycol methacrylate; wherein index n indicates the average value of the repeat-ing unit.

Preferably, the monomer of formula (h) has a content of
at least 1.2 wt.-%, preferably at least 1.5 wt.-%, more preferably at least 1.8 wt.-%, still more pref-erably at least 2.1 wt.-%, yet more preferably at least 2.4 wt.-%, even more preferably at least 2.7 wt.-%, most preferably at least 3.0 wt.-%, and in particular at least 3.3 wt.-%; and/or
at most 19 wt.-%, preferably at most 18 wt.-%, more preferably at most 17 wt.-%, still more prefer-ably at most 16 wt.-%, yet more preferably at most 15 wt.-%, even more preferably at most 14 wt.-%, most preferably at most 13 wt.-%, and in particular at most 12 wt.-%;
   in each case relative to the total weight of the component in which it is contained.

Preferably, the monomer of formula (i) is hydroxy polypropylene glycol (meth)acrylate, wherein index n is 2, 3, 4, 5, 6 or 7; preferably hydroxy polypropylene glycol acrylate, wherein index n is 5, hydroxy polypropylene glycol methacrylate, wherein index n is 5, hydroxy polypropylene glycol acrylate wherein index n is 6, or hydroxy polypropylene glycol methacrylate, wherein index n is 6; wherein index n indicates the average value of the repeating unit.

Preferably, the monomer of formula (i) has a content of
at least 2.0 wt.-%, preferably at least 4.0 wt.-%, more preferably at least 6.0 wt.-%, still more preferably at least 8.0 wt.-%, yet more preferably at least 10 wt.-%, even more preferably at least 12 wt.-%, most preferably at least 14 wt.-%, and in particular at least 16 wt.-%; and/or
at most 36 wt.-%, preferably at most 34 wt.-%, more preferably at most 32 wt.-%, still more prefer-ably at most 30 wt.-%, yet more preferably at most 28 wt.-%, even more preferably at most 26 wt.-%, most preferably at most 24 wt.-%, and in particular at most 22 wt.-%;
   in each case relative to the total weight of the component in which it is contained.

Preferably, the monomer of formula (j) is selected from the group consisting of methyl polypropylene glycol (meth)acrylate, wherein index n is 2, 3, 4, 5, 6 or 7, ethyl polypropylene glycol (meth)acrylate, wherein index n is 2, 3, 4, 5, 6 or 7, propyl polypropylene glycol (meth)acrylate, Wherein index n is 2, 3, 4, 5, 6 or 7, and butyl polypropylene glycol (meth)acrylate, wherein index n is 2, 3, 4, 5, 6 or 7; preferably methyl tripropylene glycol acrylate or methyl tripropylene glycol methacrylate; wherein index n indicates the average value of the repeating unit.

Preferably, the monomer of formula (j) has a content of
at least 2.0 wt.-%, preferably at least 4.0 wt.-%, more preferably at least 6.0 wt.-%, still more preferably at least 8.0 wt.-%, yet more preferably at least 10 wt.-%, even more preferably at least 12 wt.-
%, most preferably at least 14 wt.-%, and in particular at least 16 wt.-%; and/or
at most 36 wt.-%, preferably at most 34 wt.-%, more preferably at most 32 wt.-%, still more preferably at most 30 wt.-%, yet more preferably at most 28 wt.-%, even more preferably at most 26 wt.-%, most preferably at most 24 wt.-%, and in particular at most 22 wt.-%;
   in each case relative to the total weight of the component in which it is contained.

Preferably, the monomer of formula (k) is selected from the group consisting of cyclohexyl (meth)acrylate, methyl cyclohexyl (meth)acrylate, dimethyl cyclohexyl (meth)acrylate, trimethyl cyclo-hexyl (meth)acrylate, and tert-butyl cyclohexyl (meth)acrylate; preferably cyclohexyl acrylate, cyclo-hexyl methacrylate, trimethyl cyclohexyl acrylate, trimethyl cyclohexyl methacrylate, tert-butyl cyclo-hexyl acrylate, or tert-butyl cyclohexyl methacrylate.

Preferably, the monomer of formula (k) has a content of
at least 1.0 wt.-%, preferably at least 2.0 wt.-%, more preferably at least 3.0 wt.-%, still more preferably at least 4.0 wt.-%, yet more preferably at least 5.0 wt.-%, even more preferably at least 6.0 wt.-%, most preferably at least 7.0 wt.-%, and in particular at least 8.0 wt.-%; and/or
at most 24 wt.-%, preferably at most 23 wt.-%, more preferably at most 22 wt.-%, still more preferably at most 21 wt.-%, yet more preferably at most 20 wt.-%, even more preferably at most 19 wt.-%, most preferably at most 18 wt.-%, and in particular at most 17 wt.-%;
   in each case relative to the total weight of the component in which it is contained.

Preferably, the monomer of formula (1) is selected from the group consisting of cyclic trimethylolpropane formal (meth)acrylate ((5-ethyl-1,3-dioxan-5-yl)methyl acrylate), 2-cyclohexylethyl (meth)acrylate, and 3-cyclohexylpropyl (meth)acrylate; preferably cyclic trimethylolpropane formal acrylate or cyclic trimethylolpropane formal methacrylate.

Preferably, the monomer of formula (1) has a content of
at least 1.0 wt.-%, preferably at least 2.0 wt.-%, more preferably at least 3.0 wt.-%, still more preferably at least 4.0 wt.-%, yet more preferably at least 5.0 wt.-%, even more preferably at least 6.0 wt.-%, most preferably at least 7.0 wt.-%, and in particular at least 8.0 wt.-%; and/or
at most 24 wt.-%, preferably at most 23 wt.-%, more preferably at most 22 wt.-%, still more preferably at most 21 wt.-%, yet more preferably at most 20 wt.-%, even more preferably at most 19 wt.-%, most preferably at most 18 wt.-%, and in particular at most 17 wt.-%;
   in each case relative to the total weight of the component in which it is contained. Preferably, the monomer of formula (m) is selected from the group consisting of isobomyl (meth)acrylate, adamantyl (meth)acrylate, and norbomyl (meth)acrylate; preferably isobomyl acrylate or isobomyl methacrylate.

Preferably, the monomer of formula (m) has a content of
at least 1.8 wt.-%, preferably at least 2.1 wt.-%, more preferably at least 2.4 wt.-%, still more preferably at least 2.7 wt.-%, yet more preferably at least 3.0 wt.-%, even more preferably at least 3.3 wt.-%, most preferably at least 3.6 wt.-%, and in particular at least 3.9 wt.-%; and/or
at most 10 wt.-%, preferably at most 9.7 wt.-%, more preferably at most 9.4 wt.-%, still more preferably at most 9.1 wt.-%, yet more preferably at most 8.8 wt.-%, even more preferably at most 8.5 wt.-%, most preferably at most 8.2 wt.-%, and in particular at most 7.9 wt.-%;
   in each case relative to the total weight of the component in which it is contained.

Preferably, the monomer of formula (n) is 2-(1-oxa-4-azaspiro(4.5)dec-4-yl)ethyl (meth)acrylate; preferably 2-(1-oxa-4-azaspiro(4.5)dec-4-yl)ethyl methacrylate.

Preferably, the monomer of formula (n) has a content of
at least 1.8 wt.-%, preferably at least 2.1 wt.-%, more preferably at least 2.4 wt.-%, still more preferably at least 2.7 wt.-%, yet more preferably at least 3.0 wt.-%, even more preferably at least 3.3 wt.-%, most preferably at least 3.6 wt.-%, and in particular at least 3.9 wt.-%; and/or
at most 10 wt.-%, preferably at most 9.7 wt.-%, more preferably at most 9.4 wt.-%, still more preferably at most 9.1 wt.-%, yet more preferably at most 8.8 wt.-%, even more preferably at most 8.5 wt.-%, most preferably at most 8.2 wt.-%, and in particular at most 7.9 wt.-%;
   in each case relative to the total weight of the component in which it is contained.

Preferably, the monomer of formula (o) is phenyl (meth) acrylate; preferably phenyl methacrylate.

Preferably, the monomer of formula (o) has a content of
at least 3.0 wt.-%, preferably at least 4.0 wt.-%, more preferably at least 5.0 wt.-%, still more preferably at least 6.0 wt.-%, yet more preferably at least 7.0 wt.-%, even more preferably at least 8.0 wt.-%, most preferably at least 9.0 wt.-%, and in particular at least 10 wt.-%; and/or
at most 27 wt.-%, preferably at most 26 wt.-%, more preferably at most 25 wt.-%, still more preferably at most 24 wt.-%, yet more preferably at most 23 wt.-%, even more preferably at most 22 wt.-
%, most preferably at most 21 wt.-%, and in particular at most 20 wt.-%;
   in each case relative to the total weight of the component in which it is contained.

Preferably, the monomer of formula (p) is selected from the group consisting of 1,4-butanediol di(meth)acrylate, 1,6-hexanediol di(meth)acrylate, and 1,10-decanediol di(meth)acrylate; preferably 1,6-hexanediol diacrylate or 1,6-hexanediol dimethacrylate.

Preferably, the monomer of formula (p) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the monomer of formula (q) is selected from polyethylene glycol di(meth)acrylates, wherein index n is 1, 2, 3, 4, 5, 6, 7, 8, 9, 10, 11 or 12; preferably triethylene glycol diacrylate, triethylene glycol dimethacrylate, polyethylene glycol diacrylate, wherein index n is 4, or polyethylene glycol dimethacrylate, wherein index n is 4; wherein index n indicates the average value of the repeating unit.

Preferably, the monomer of formula (q) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the monomer of formula (s) is tricyclodecane dimethanol di(meth)acrylate; preferably tricyclodecane dimethanol dimethacrylate.

Preferably, the monomer of formula (s) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the monomer of formula (t) is selected from the group consisting of bisphenol A polyethoxylate di(meth)acrylate, wherein index n is 1.5, 2, 5 or 15; preferably bisphenol A ethoxylate diacrylate, wherein index n is 2, or bisphenol A ethoxylate dimethacrylate, wherein index n is 2.

Preferably, the monomer of formula (t) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the monomer of formula (u) is selected from the group consisting of tris(2-hydrox-yethyl) isocyanurate tri(meth)acrylate and 1,3,5-triazine-2,4,6-tris(2-hydroxyethyl) tri(meth)acrylate; preferably tris(2-hydroxyethyl) isocyanurate triacrylate or tris(2-hydroxyethyl) isocyanurate trimethac-rylate.

Preferably, the monomer of formula (u) has a content of
at least 1.0 wt.-%, preferably at least 1.5 wt.-%, more preferably at least 2.0 wt.-%, still more preferably at least 2.5 wt.-%, yet more preferably at least 3.0 wt.-%, even more preferably at least 3.5 wt.-%, most preferably at least 4.0 wt.-%, and in particular at least 4.5 wt.-%; and/or
at most 9.0 wt.-%, preferably at most 8.5 wt.-%, more preferably at most 8.0 wt.-%, still more preferably at most 7.5 wt.-%, yet more preferably at most 7.0 wt.-%, even more preferably at most 6.5 wt.-%, most preferably at most 6.0 wt.-%, and in particular at most 5.5 wt.-%;
   in each case relative to the total weight of the component in which it is contained.

Preferably, the first and/or the optionally present second curable ingredient independently of one another comprises or essentially consists of monomers wherein in each case R means —CH3.

Preferably, the polymerization initiator is a peroxide polymerization initiator; preferably selected from the group consisting of benzoyl peroxide, tert-butyl hydroperoxide, ditert-butyl peroxide, cumene hydroperoxide, dicumene peroxide, tert-butyl peracetate, tert-butyl perbenzoate, and ditert-butyl perphthalate; preferably benzoyl peroxide.

Preferably, the content of the peroxide polymerization initiator is within the range of 3.5±3.4 wt.-%, more preferably 3.5±3.0 wt.-%, still more preferably 3.5±2.5 wt.-%, yet more preferably 3.5±2.0 wt.-%, even more preferably 3.5±1.5 wt.-%, most preferably 3.5±1.0 wt.-%, and in particular 3.5±0.5 wt.-%, and in particular 20±2.5 wt.-%, in each case relative to the total weight of the two-component acrylic adhesive.

Preferably, the content of the peroxide polymerization initiator is within the range of 20±17.5 wt.-%, more preferably 20±15 wt.-%, still more preferably 20±12.5 wt.-%, yet more preferably 20±10 wt.-%, even more preferably 20±7.5 wt.-%, most preferably 20±5.0 wt.-%, in each case relative to the total weight of the second component.

When the two-component acrylic adhesive comprises more than one peroxide polymerization initiator, the specified content of peroxide polymerization initiator refers to the overall content of all peroxide polymerization initiators that are contained in the two-component acrylic adhesive.

Preferably, the polymerization initiator is a redox polymerization initiator, wherein an oxidizing agent and a reducing agent are combined; the oxidizing agent preferably is selected from the group consisting of persulfates such as potassium persulfate, sodium persulfate, and ammonium persulfate, hydrogen peroxide, tert-butyl hydroperoxide, tert-butyl peroxymaleic acid, succinic peroxide, benzoyl peroxide, cumene hydroperoxide, diisopropyl peroxydicarbonate, cumyl peroxyneodecanoate, cumyl peroxy octanoate, diisopropylbenzene hydroperoxide, and p-menthane hydroperoxide; the reducing agent is selected from the group consisting of acidic sodium sulfite, sodium dithionite, sodium thiosul-fate, rongalite, ascorbic acid, fructose and other reducing saccharides, ferrous sulfate, ferric sulfate and other iron salts.

Preferably, the content of the redox polymerization initiator is within the range of 3.5±3.4 wt.-%, more preferably 3.5±3.0 wt.-%, still more preferably 3.5±2.5 wt.-%, yet more preferably 3.5±2.0 wt.-%, even more preferably 3.5±1.5 wt.-%, most preferably 3.5±1.0 wt.-%, and in particular 3.5±0.5 wt.-%, in each case relative to the total weight of the two-component acrylic adhesive.

Preferably, the content of the redox polymerization initiator is within the range of 20±17.5 wt.-%, more preferably 20±15 wt.-%, still more preferably 20±12.5 wt.-%, yet more preferably 20±10 wt.-%, even more preferably 20±7.5 wt.-%, most preferably 20±5.0 wt.-%, in each case relative to the total weight of the second component.

When the two-component acrylic adhesive comprises more than one redox polymerization ini-tiator, the specified content of redox polymerization initiator refers to the overall content of all redox polymerization initiators that are contained in the two-component acrylic adhesive.

The two-component acrylic adhesive according to the invention is curable and foamable at am-bient temperature (23° C.), i.e. spontaneously starts curing and foaming once the first component and the second component have been mixed with one another. Nonetheless, it is also contemplated that curing and/or foaming may be accelerated by subjecting the mixture to elevated temperature. Further, it is contemplated that the mixture may heat during the curing process as curing is typically an exothermic reaction. Thus, curing and/or foaming may occur at temperatures above ambient temperature (23° C.).

Preferably, the first component and/or the second component additionally comprise at least one, preferably at least two, more preferably at least three and most preferably all four of
a first toughening agent;
a second toughening agent differing from the first toughening agent;
a first impact modifier; and
a second impact modifier differing from the first impact modifier.

The first toughening agent, the second toughening agent, the first impact modifier and the sec-ond impact modifier differ from one another.

Preferably, the two-component acrylic adhesive according to the invention comprises a first toughening agent and optionally and preferably, a second toughening agent that differs from the first toughening agent. The terms “first” and “second” are merely be used for ease of reference. It is contemplated that the two-component acrylic adhesive according to the invention only contains a first tough-ening agent but not a second toughening agent, or only a second toughening agent but not a first tough-ening agent, or both a first toughening agent as well as a second toughening agent.

Elastomers and polymers employed as toughening agents may have a glass transition tempera-ture (T_{g}) of less than −25° C., and advantageously less than −50° C. Further, these toughening agents may beneficially be soluble in the acrylic monomers described above. In general, the elastomers may include synthetic high polymers. Moreover, the elastomers may be supplied commercially as adhesive grades.

Elastomers and polymers may include polychloroprene (neoprene) and block-copolymers of butadiene or isoprene with styrene, acrylonitrile, acrylates, methacrylates, and the like.

Preferably, the first toughening agent is a liquid toughening agent; preferably selected from aliphatic and aromatic urethane (meth)acrylate, epoxy (meth)acrylate, polyester (meth)acrylate, (meth)acrylate terminated butadiene-acrylonitrile copolymers, (meth)acrylate (vinyl) terminated buta-diene-acrylonitrile copolymers (commercially available e.g. as Hypro™ 2000X168LC VTB) and, (meth)acrylate-terminated poly(butadiene-acrylonitrile-acrylic acid) terpolymers; preferably a (meth)acrylate terminated butadiene-acrylonitrile copolymer. Preferably, the butadiene acrylonitrile backbone is a random copolymer backbone with a content of more than 50 wt.-% butadiene, more pref-erably at least 60 wt.-%, still more preferably at least 70 wt.-%, and in particular at least 80 wt.-%, the remainder being acrylonitrile. First toughening agents of this type are commercially available (e.g. Hypro™ 1300X33LC VTBNX, Hypro™ 1300X43VTBNX).

Preferably, the content of the first toughening agent is within the range of 20±15 wt.-%, relative to the total weight of the first component; preferably 15±10 wt.-%, more preferably 15±8.0 wt.-%, still more preferably 15±6.0 wt.-%, yet more preferably 15±4.0 wt.-%, even more preferably 15±2.0 wt.-%, most preferably 10±8.0 wt.-%, and in particular 10±4.0 wt.-%.

Preferably, the second toughening agent is a solid toughening agent; preferably selected from the group consisting of styrene-butadiene-styrene block-copolymers (SBS), styrene-isoprene-styrene block-copolymers (SIS), styrene-ethylene-propylene block-copolymers (SEP), styrene-ethylene-butadiene-styrene block-copolymers (SEBS), ethylene-propylene rubbers (EPR), acrylonitrile-butadi-ene rubbers (NBR), ethylene-propylene-diene rubbers (EPDM), butadiene rubbers (BR), natural rubbers (NR), styrene-butadiene rubbers (SBR), thermoplastic polyolefin elastomers (POE), ethylene acrylic acid copolymers (EAA), ethylene-vinyl acetate or a mixture of several ethylene copolymers (EVA); preferably a styrene-butadiene-styrene block-copolymer (SBS). Second toughening agents of this type are commercially available (e.g. Kraton™ D1102, Kraton™ D1116, Kraton™ D1 118, Kraton™ D1 133, Kraton™ D1152 ESM, Kraton™ D1153, Kraton™ D1155, Kraton™ D1192).

Preferred second toughening agents include copolymers (e.g., block-copolymers) having a glass transition temperature, Tg, of at least one domain in the range of in the range of −50° C. to −110° C. Embodiments of these toughening agents include styrene-butadiene-styrene (SBS) copolymers. Commercial examples of SBS copolymers are Kraton™ D1116, Kraton D1152 ESM and Kratone™ 1184 (KRATON).

Preferably, the content of the second toughening agent is within the range of 7.0±5.0 wt.-%, relative to the total weight of the first component; preferably 7.0±4.0 wt.-%, more preferably 7.0±3.0 wt.-%, still more preferably 7.0±2.0 wt.-%, and most preferably 7.0±1.0 wt.-%.

The two-component acrylic adhesive according to the invention preferably does not contain a chlorinated toughening agent, or when the two-component acrylic adhesive contains a chlorinated toughening agent, its content is at most 5.0 wt.-%, relative to the total weight of the two-component acrylic adhesive.

Preferably, the two-component acrylic adhesive according to the invention comprises a first impact modifier and optionally and preferably, a second impact modifier that differs from the first im-pact modifier. The terms “first” and “second” are merely be used for ease of reference. It is contemplated that the two-component acrylic adhesive according to the invention only contains a first impact modifier agent but not a second impact modifier, or only a second impact modifier but not a first impact modifier, or both a first impact modifier as well as a second impact modifier.

The acrylic adhesive formulated with impact modifiers exhibit desirable properties for many adhesive applications. For example, impact modifiers have a similar effect on the cured adhesives as toughening agents in reducing brittleness and increasing impact strength of the cured adhesives. The impact modifiers may also provide improved non-sag and thixotropic properties, and anti-sliding per-formance in the uncured adhesives.

The impact modifiers according to the invention generally include graft copolymers that may be characterized as core-shell copolymers having a rubbery “core,” a hard “shell,” and that swell in the methacrylate and/or acrylate monomer compositions but do not dissolve therein. Examples of core-shell copolymers are those where the hard “shell” monomers, such as styrene, acrylonitrile, or methyl methacrylate, are grafted onto a rubbery “core” made from polymers of butadiene, butyl acrylate, ethyl acrylate, isoprene and the like. One type of core-shell polymers is methacrylate butadiene styrene (MBS) copolymer made by polymerizing methyl methacrylate in the presence of polybutadiene or a polybuta-diene copolymer rubber. Commercial examples of core shell impact modifiers are Paraloid™ BTA-753, Paraloid 2650A, Paraloid 2691A, Clearstrength® E920, Clearstrength XT 100, and Kane Ace™ B-564 or Kane Ace™ M521.

Preferably, the first impact modifier is a first core shell impact modifier. Preferably, the first impact modifier is selected from impact modifiers based on butadiene, isoprene, ethylene-propylene and ethylene-butylene in combination with styrene, acrylonitrile and acrylic monomers; acrylonitrile buta-diene styrene (ABS) impact modifiers; methacrylate butadiene styrene (MBS) impact modifiers; and MABS impact modifiers. In a preferred embodiment, the first impact modifier is a (methyl) methacrylate butadiene styrene (MBS) core shell impact modifier. Thus, the first impact modifier preferably is a core-shell copolymer where hard “shell” acrylate monomers (preferably (methyl)methacrylates) are grafted onto a rubbery “core” made from butadiene styrene rubber. First impact modifiers of this type are com-mercially available (e.g. Kane Ace™ B564, Kane Ace™ M521, Clearstrength™ XT 100, Paraloid 2650A, Paraloid 2691A, Clearstrength® E920, Clearstrength XT 100). In another preferred embodi-ment, the first impact modifier is a core shell polybutadiene rubber, which may be dispersed in liquid bisphenol A epoxy resin (e.g. Kane Ace™ MX257).

Preferably, the content of the first impact modifier is within the range of 25±20 wt.-%, relative to the total weight of the first component; preferably 25±15 wt.-%, more preferably 25±10 wt.-%, and most preferably 25±4.0 wt.-%.

Preferably, the second impact modifier is a second core shell impact modifier; preferably a core shell impact modifier having an all-acrylic core shell based on butyl-acrylate rubber. Thus, the second impact modifier preferably is a core-shell copolymer where hard “shell” acrylate monomers (preferably (methyl)methacrylates) are grafted onto a rubbery “core” made from butyl acrylate rubber. First impact modifiers of this type are commercially available (e.g. Paraloid™ EXL-2300G, Paraloid EXL-2314, Paraloid EXL 3361).

Preferably, the content of the second impact modifier is within the range of 5.0±4.0 wt.-%, rel-ative to the total weight of the first component.

Preferably, the total content of the first impact modifier and the second impact modifier is at least 10 wt.-%, relative to the total weight of the first component; preferably at least 15 wt.-%, and more preferably at least 20 wt.-%.

Preferably, total content of the first impact modifier and the second impact modifier is at least 25 wt.-%, relative to the total weight of the first component.

Preferably, the two-component acrylic adhesive, preferably the first component additionally comprises an accelerator; preferably a metal di(meth)acrylate; more preferably a metal di(meth)acrylate selected from zinc di(meth)acrylate, aluminum di(meth)acrylate and magnesium di(meth)acrylate; most preferably zinc dimethacrylate.

Further accelerators include but are not limited to organic transitional metal compounds, such as copper acetyl acetonate, vanadium acetyl acetonate, and the like. In general, the accelerators may be organic salts of a transition metal, such as cobalt, nickel, manganese or iron naphthenate, copper octoate, copper acetylacetonate, iron hexoate, iron propionate, and the like. Accelerators are commercially avail-able (e.g. Dymalink™ 708, Dymalink™ 709).

Preferably, the content of the accelerator is within the range of 1.0±0.8 wt.-%, relative to the total weight of the first component; preferably within the range of 1.0±0.6 wt.-%, more preferably 1.0±0.4 wt.-%, and most preferably 1.0±0.3 wt.-%.

Preferably, the two-component acrylic adhesive, preferably the first component additionally comprises a curative (curing accelerator); preferably a curative selected from N,N-dimethyl-para-tolui-dine (DMPT), N-(2-hydroxyethyl)-N-methyl-para-toluidine (MHPT), N-methyl-N-(2-hydroxypropyl)-p-toluidine (2HPMT), and N-ethyl-N-(2-hydroxyethyl)-p-toluidine (EHPT); more preferably N-(2-hydroxyethyl)-N-methyl-para-toluidine. Curatives are commercially available (e.g. Firstcure™ MHPT).

The curative (curing accelerator) of the first component may react with the radical initiator of the second component after the first and second component have been mixed with one another and thereby generate a free radical that induced polymerization and curing. As polymerization and curing is typically an exothermic reaction, the polymerizing and curing acrylic adhesive warms up and depending upon the heat activation temperature of the polymerization initiator (e.g. peroxide), further free radicals may be generated by homolysis.

Preferably, the content of the curative is within the range of 1.5±1.4 wt.-%, relative to the total weight of the first component; preferably within the range of 1.5±1.2 wt.-%, more preferably within the range of 1.5±1.0 wt.-%.

Preferably, the two-component acrylic adhesive, preferably the first component additionally comprises a curing catalyst; preferably triphenylphosphine.

Preferably, the content of the curing catalyst is within the range of 1.5±1.4 wt.-%, relative to the total weight of the first component; preferably within the range of 1.5±1.2 wt.-%, more preferably within the range of 1.5±1.0 wt.-%.

Preferably, the first component and/or the second component additionally comprises a stabilizer; preferably a stabilizer selected from the group consisting of phenols, quinones, hydroquinones, thia-zines, phenothiazines, N-oxyls, aromatic amines, phenylenediamines, sulfonamides, oximes, hydroxyl-amines, urea derivatives, phosphorus compounds, sulfur compounds and metal salts; more preferably mono-tert-butyl hydroquinone (MTBHQ) and/or 10H-phenothiazine.

Such stabilizers are normally used to prevent premature polymerization and curing and to help the polymerization initiator to provide for a desired and consistent cure profile, and thus a consistent working time. Further examples include but are not limited to combinations of butylated hydroxytoluene (BHT or 2,6-di-tert-butyl-p-cresol) and quinone(s), which commonly may be employed for medium and long open time adhesives. A specific example of an inhibitor/retardant system is a combination of bu-tylated hydroxytoluene (BHT) and hydroquinone (HQ).

Preferably, the content of the stabilizer is within the range of 0.025±0.015 wt.-%, relative to the total weight of the first component; preferably within the range of 0.025±0.01 wt.-%, and more prefer-ably within the range of 0.025±0.005.

Preferably, the first component and/or the second component additionally comprises a filler; preferably an inorganic filler; more preferably a filler selected from kaolin, silica, talc, calcium car-bonate, carbon black, titanium oxides, and the pigments used to color material; most preferably silica.

In a preferred embodiment of the invention, the viscosity of the first component and/or the sec-ond component is controlled by adjusting type and amount of first impact modifier and optionally, sec-ond modifier. According to this embodiment, the nature and amount of filler preferably does not or not significantly contribute to the viscosity of the first component and/or the second component. According to this embodiment, the filler essentially may serve the purposes of reducing costs, providing color (pig-ment), improving reinforcement (e.g. fibers), and the like.

In another preferred embodiment of the invention, the viscosity of the first component and/or the second component is controlled by adjusting type and amount of filler. According to this embodi-ment, thixotropic fillers are preferred.

Preferably, the content of the filler is within the range of 5.0±4.8 wt.-%, relative to the total weight of the first component.

Preferably, the first component and/or the second component additionally comprises a polymer; preferably an epoxy resin, polyurethane, isocyanate, (meth)acrylate ester or any combination thereof. Elastomers may also be added. These additional polymers may further alter the properties of the acrylic adhesive, e.g. may increase elongation and/or increase modulus (e.g. tensile modulus, Young's modulus, impact modulus and the like) and/or increase strength (e.g. tensile strength, T-peel strength, lap shear strength, and the like).

Preferably, the second component additionally comprises a polymer and the content of said pol-ymer is within the range of 10±2.5 wt.-%, relative to the total weight of the second component; prefer-ably 9.0±2.5 wt.-%, more preferably 8.0±2.5 wt.-%, still more preferably 7.0±2.5 wt.-%, yet more pref-erably 6.0±2.5 wt.-%, even more preferably 5.0±2.5 wt.-%, most preferably 4.0±2.5 wt.-%, and in par-ticular 3.0±2.5 wt.-%.

Preferably, the content of the polymer is within the range of 10±2.5 wt.-%, relative to the total weight of the two-component acrylic adhesive; preferably 9.0±2.5 wt.-%, more preferably 8.0±2.5 wt.-%, still more preferably 7.0±2.5 wt.-%, yet more preferably 6.0±2.5 wt.-%, even more preferably 5.0±2.5 wt.-%, most preferably 4.0±2.5 wt.-%, and in particular 3.0±2.5 wt.-%.

It has been found that the epoxy resin inter alia increases Tg of the acrylic adhesive.

Preferably, the epoxy resin comprises epoxy functional groups that are capable of reacting e.g. with the carboxylic acid functional groups of the (meth)acrylic acid. In order to avoid premature reac-tion, the epoxy resin is preferably contained in the second component, i.e. spatially separate from the (meth)acrylic acid that is contained in the first component.

Exemplary epoxy resins include but are not limited to phenolic resins, which may be a novolac type or other type resin. Other preferred epoxy resins include bisphenol-A epichlorohydrin ether poly-mer, or a bisphenol-A epoxy resin which may be modified with butadiene or another polymeric additive, or bisphenol- F-type epoxy resins. Moreover, various mixtures of several different epoxy resins may be employed as well. Examples of suitable epoxy resins are sold under the tradename DER330, DER33 1, Araldite™ GY 250, Araldite™ GY 260, Araldite™ GY 282, Araldite™ GY 281, Araldite™ GY 285, YD128, Epikote™ 828, DER 354, Epikote™ 862, Epikote™ 864, Epikote™ 869.

Preferably, the first component of the two-component acrylic adhesive according to the inven-tion additionally comprises a cure indicator; preferably a triphenylmethane derivative, e.g. bis(dime- thylamino)triphenylmethane or tris(dimethylamino)triphenylmethane. Cure indicators change their color during the polymerization and curing reaction thereby visually indicating the progress of polymer-ization and curing. Suitable cure indicators are disclosed in e.g. WO 98/34980 and U.S. 2013/292054, both incorporated by reference.

Preferably, the content of the cure indicator is at most 0.10 wt.-%, more preferably at most 0.09 wt.-%, still more preferably at most 0.08 wt.-%, yet more preferably at most 0.07 wt.-%, even more preferably at most 0.06 wt.-%, most preferably at most 0.05 wt.-%, in each case relative to the total weight of the two-component acrylic adhesive. Preferably, the cure indicator is contained at a concen-tration that is so low that the cure indicator as such has no influence of the progress of the polymerization and curing reaction.

Preferably, the relative weight and/or volume ratio of the first component to the second compo-nent is within the range of from 20:1 to 1:1, preferably 15:1 to 1:1, and more preferably 10:1 to 1:1.

A skilled person recognizes that other relative weight ratios can easily be realized and thus are also contemplated.

Conventional methods for preparing two-component acrylic adhesives with a first component that is spatially separated from a second component in order to prevent premature reaction are known to the skilled person. Certain ingredients, such as the toughening agents and impact modifiers may be apportioned between the first component and the second component to provide for a similar viscosity of the first component and the second component. As indicated, the volume ratio and/or weight ratio between the first component and the second component can vary greatly, for example, from 20:1 to 1:1. In some embodiments, the ratio between the first component and the second component is 10:1 by vol-ume or weight.

It should be noted that the order of addition in making the first component and the second component can vary greatly. Moreover, the commercial preparation of the first component and the second component may also involve making stock or premix solutions, cooling the formulations at intermediate and final steps, degassing the formulations under a vacuum, and the like. As appreciated by a skilled person, equipment that may be employed in making the first component and the second component include vessels, piping, valves, transfer pumps, vacuum pumps, mixers (e.g., high speed agitators or dispersers), and so forth. The first component and the second component may be delivered to the end-user in differing types of containers, ranging from small cartridges to drums, and the like.

After preparation of the first component and the second component of the two-component acrylic adhesive according to the invention, the two components may be stored in inventory by the manufacturer, the distributor, end-user, and the like. The first component and the second component may alternatively be used or applied soon after transport (without intermediate storage) to bond sub-strates. However, it is common for either the manufacturer or the user to store the first component and the second component prior to combination and use of the two components. Thus, it is generally bene-ficial to have a consistent cure profile over the shelf life of the first component and the second compo-nent. Again, it is generally desirable for the user to know the behavior of the cure profile (e.g., peak exotherm temperature and time) to appropriately manage the application of the two-component acrylic adhesive and the construction/bonding of the structural components, pieces, parts, and the like. There-fore, ingredients, such as cure profile regulators, cure accelerators, and stabilizers are added to the two-component acrylic adhesive to provide for a more consistent cure profile. These ingredients may be added to the first component, to the second component, or to both.

The two-component acrylic adhesive according to the invention preferably is odorless.

The two-component acrylic adhesive according to the invention preferably is nonflammable.

In preferred embodiments, particularly for applications as structural adhesive, the two-compo-nent acrylic adhesive according to the invention preferably provides a volume expansion relative to its original volume of at least 110 vol.-% (i.e. relative increase by 10 vol. %), preferably at least 120 vol.-%, more preferably at least 130 vol.-%, still more preferably at least 140 vol.-%, yet more preferably at least 150 vol.-%, even more preferably at least 160 vol.-%, most preferably at least 170 vol.-%, and in particular at least 180 vol.-%.

In other preferred embodiments, particularly for applications as sealant, the two-component acrylic adhesive according to the invention preferably provides a volume expansion relative to its original volume of at least 200 vol.-%, preferably at least 300 vol.-%, more preferably at least 400 vol.-%, still more preferably at least 500 vol.-%, yet more preferably at least 750 vol.-%, even more preferably at least 1000 vol.-%, most preferably at least 1500 vol.-%, and in particular at least 2000 vol.-%.

Volume expansion can be adjusted by the content of the first and the second constituent of the binary chemical foaming agent.

The two-component acrylic adhesive according to the invention preferably provides gap filling of up to 100 mm without boiling, preferably at open times within the range of 1 to 30 minutes, preferably 2 to 20 minutes or even 2 to 10 minutes. Gap filling is preferably determined in accordance with ASTM method D3931-08(2015).

The two-component acrylic adhesive according to the invention preferably provides an elongation at break
of at least 10%, preferably at a Young's modulus of at least 100 MPa, preferably at least 200 MPa, more preferably of at least 400 MPa, and most preferably of at least 600 MPa;
of at least 20%, preferably at a Young's modulus of at least 100 MPa, preferably at least 200 MPa, more preferably of at least 400 MPa, and most preferably of at least 600 MPa;
of at least 30%, preferably at a Young's modulus of at least 100 MPa, preferably at least 200 MPa, more preferably of at least 400 MPa, and most preferably of at least 600 MPa;
of at least 40%, preferably at a Young's modulus of at least 100 MPa, preferably at least 200 MPa, more preferably of at least 400 MPa, and most preferably of at least 600 MPa;
of at least 50%, preferably at a Young's modulus of at least 400 MPa, preferably at least 500 MPa, more preferably of at least 600 MPa, and most preferably of at least 700 MPa;
of at least 70%, preferably at a Young's modulus of at least 400 MPa, preferably at least 500 MPa, more preferably of at least 600 MPa, and most preferably of at least 700 MPa;
of at least 75%, preferably at a Young's modulus of at least 400 MPa, preferably at least 500 MPa, more preferably of at least 600 MPa, and most preferably of at least 700 MPa;
within the range of 5% to 50%, preferably at a Young's modulus of at least 800 MPa, more preferably of at least 900 MPa, and most preferably of at least 1 GPa; or
within the range of 10% to 40%, preferably at a Young's modulus of at least 800 MPa, more prefer-ably of at least 900 MPa, and most preferably of at least 1 GPa;
   Young's modulus and elongation at break are preferably determined in accordance with ASTM method D638-14.

The two-component acrylic adhesive according to the invention preferably provides a tensile strength of at least 2.0 MPa, preferably at least 3.0 MPa, more preferably at least 4.0 MPa, still more preferably at least 5.0 MPa, yet more preferably at least 7.5 MPa, even more preferably at least 10 MPa, most preferably at least 12.5 MPa, and in particular at least 15 MPa. The tensile strength is preferably determined in accordance with EN ISO DIN 53504:2017-03.

The two-component acrylic adhesive according to the invention preferably provides a T-peel strength of at least 1.0 N/mm, preferably at least 2.0 N/mm, more preferably at least 3.0 N/mm, still more preferably 5.0 N/mm, even more preferably 7.5 N/mm, most preferably at least 10 N/mm, and in particular 12.5 N/mm. The T-peel strength is preferably determined in accordance with ASTM method D1876-08(2015)el.

The two-component acrylic adhesive according to the invention preferably provides a lap shear strength of at least 1.0 MPa, preferably at least 2.0 MPa, more preferably at least 3.0 MPa, still more preferably at least 4.0 MPa, yet more preferably at least 5.0 MPa, even more preferably at least 7.5 MPa, most preferably at least 12.5 MPa, and in particular at least 15 MPa, wherein the lap shear strength is preferably determined in accordance with ASTM method D1002-10 (2019).

The two-component acrylic adhesive according to the invention preferably exhibits a shrinkage determined using a rheometer or a pycnometer of not more than 18 vol.-%, preferably not more than 17 vol.-%, more preferably not more than 16 vol.-%, still more preferably not more than 15 vol.-%, yet more preferably not more than 14 vol.-%, even more preferably not more than 13 vol.-%, most prefera-bly not more than 12 vol.-%, and in particular not more than 10 vol.-%.

Conventional methods for the determination of shrinkage using a rheometer (e.g. TA Instru-ments AR/DHR and ARES-G2) or a pycnometer (e.g. Micromeritics AccuPyc® II 1340) are known to the skilled person.

To apply the adhesive, the first component and the second component are combined or mixed together, (e.g., through a static mixer). The combined first component and the second component may then be applied to a first substrate and/or a second substrate which may be located in a cavity. After such application, the first substrate and the second substrate may be adhered to one another via the applied acrylic adhesive, i.e. via the combined first component and the second component. Lastly, the adhesive is allowed to cure and foam, typically at ambient temperature (23° C.).

When the adhesive is applied to a cavity, the first component and the second component are preferably also combined or mixed together, and the thus combined first component and the second component may then be applied to a first inner wall of the cavity. After such application, the adhesive is allowed to cure and foam within the cavity, typically at ambient temperature (23° C.), thereby filling the cavity with the foam. Once the cavity has been filled with the foam, the thus expanded adhesive foam preferably comes in contact with other inner walls of the cavity thereby adhering them to one another.

The open time (working time) is generally regarded as the time allowable between when the two-component acrylic adhesive is mixed/applied to parts and parts must be assembled (mated). This amount of time is determined by the cure rate of the two-component acrylic adhesive and is, therefore, also dependent on temperature and the mass of the two-component acrylic adhesive. For the purpose of the specification, open time is the time span which may elapse after the first component and the second component have been mixed with one another and immediately thereafter have been applied to substrates, but before the substrates are assembled, which still provides essentially equivalent bond strength after assembling of substrates and complete curing of the adhesive. Open time is determined in a comparative experiment comparing bond strengths with one another. In the reference experiment, the first component and the second component are mixed with one another, immediately thereafter the mixture is applied to substrates, and immediately thereafter the substrates are assembled. The adhesive is allowed to fully cure and the thus achieved bond strength is the reference bond strength. In a series of test experiments, the first component and the second component are mixed with one another, immediately there-after the mixture is applied to substrates, but before the substrates are assembled, in each case a prede-termined time span elapses. After the substrates have been assembled, the adhesive is again allowed to fully cure and the thus achieved bond strengths are the test bond strengths. When a given test bond strength is essentially equivalent compared to the reference bond strength, the corresponding elapsed time span is within the open time. When a given test bond strength is not essentially equivalent compared to the reference bond strength, the corresponding elapsed time span is outside the open time.

For the purpose of the specification, the open time is defined as the maximum time span that may elapse thereby still delivering essentially equivalent bond strength as the reference bond strength, i.e. as if the substrates were immediately assembled upon initial application of the mixed two components. In this context “essentially equivalent” bond strength is commonly understood to be within 10% of the bond strength achieved with immediate assembling of the substrates. Further, bond strength is commonly expressed in terms of lap shear strength reported as the failure stress in the adhesive, which is calculated by dividing the failing load by the bond area. Preferably, the lap shear strength is determined according to ASTM method D1002-10(2019).

Preferably, open time is measured through the Delayed Mating Open Time (DMOT) test. In this test, adhesive is applied to a series of 2.54 cm (1″)×10.16 cm (4″) aluminum coupons as quickly as possible, then coupons are assembled (mated) with a delay of successively longer intervals of time, with 1.27 cm (0.5″) overlap between the two coupons and a 254 μm (10 mil) bond line thickness. The adhesive is then allowed to cure completely (typically overnight), and the coupons are pulled apart in shear. The results of lap shear strength (LSS) and failure mode (adhesive vs. cohesive) are compared for each coupon to one assembled with effectively zero delay, and the end of the open Time is then judged by a reduction in strength of >10% of the original and/or reduction in cohesive failure to <80% (>20% adhesive failure).

The two-component acrylic adhesive according to the invention preferably provides an open time within the range of 1 to 30 minutes, preferably 2 to 20 minutes or even 2 to 10 minutes.

In preferred embodiments, the two-component acrylic adhesive according to the invention provides an open time within the range of 5.0±2.5 minutes, or 7.5±5.0 minutes, or 7.5±2.5 minutes, or 10±7.5 minutes, or 10±5.0 minutes, or 10±2.5 minutes, or 12.5±10 minutes, or 12.5±7.5 minutes, or 12.5±5.0 minutes, or 12.5±2.5 minutes.

For the purpose of the specification, the time to handling strength (curing/foaming time, fixture time) is defined as the time required after the mixture of the first component and the second component has been applied and assembled for the bond strength to exceed a value of 0.689 MPa (100 psi). A longer open time typically results in a longer time to handling strength. It is generally most desirable to have a time to handling strength that is minimally longer than the open time, sometimes referred to as “snap cure” or “cure on command”. Typically, final bond strength after curing is complete is much higher than 0.689 MPa (100 psi), typically greater than 10 MPa.

Preferably, time to handling strength is measured through the Rate of Bond Strength Development (ROBSD) test. In this test, adhesive is applied to a series of2.54 cm (1″)×10.16 cm (4″) aluminum coupons which are then immediately assembled (mated) to a second coupon with 1.27 cm (0.5″) overlap and a 254 μm (10 mil) bond line thickness. The coupons are then pulled apart in shear over successively longer intervals of time, evaluating the lap shear strength over time as the adhesive cures and bond strength increases. The time to handling strength is judged by the time that it takes for the bond strength to reach 0.689 MPa (100 psi).

The two-component acrylic adhesive according to the invention preferably provides a time to handling strength within the range of 7 to 28 minutes, preferably 8 to 27 minutes, more preferably 8 to 25 minutes, still more preferably 8 to 20 minutes, most preferably 8 to 10 minutes.

Open time and time to handling strength can be purposefully adjusted by varying type and individual amount of adhesion promoter, accelerator, curative, stabilizer, and polymerization initiator. Thus, adjusting open time and time to handling strength can be achieved by routine experimentation. When the amount/concentration of adhesion promoter is increased, the open time and the time to handling strength are typically extended. When the amount/concentration of accelerator is increased, the time to handling strength is typically shortened. When the amount/concentration of curative is increased, the open time and the time to handling strength are shortened. When the amount/concentration of the stabilizer is increased, the open time and the time to handling are typically extended. The individual effect of the polymerization initiator depends upon the nature and amount of monomers to be polymerized.

Another aspect of the invention relates to the use of a two-component acrylic adhesive according to the invention as described above as acrylic adhesive.

Another aspect of the invention relates to a method of bonding two substrates comprising the steps of
(a) mixing the first component as described above and the second component as described above with one another thereby providing a combined first component and the second component;
(b) applying the combined first component and the second component obtained in step (a) to a first substrate and/or a second substrate;
(c) optionally, allowing time to elapse prior to expiry of the open time, e.g. for performing some other action;
(d) adhering the first substrate and the second substrate to one another; and
(e) allowing the combined first component and the second component to cure thereby providing a cured acrylic adhesive.

The following examples further illustrate the invention but are not to be construed as limiting its scope.

Two-component acrylic adhesives were manufactured comprising a first component having the following ingredients at the following weight contents. The first component (Part A) was mixed with the second component (Pat B) and the mixture was applied to a substrate. Foam time and fixture time were determined:

| | | | | |
|---|---|---|---|---|
| 1 | 2 | 3 | 4 | 5 |

Part A

| | | | | | | |
|---|---|---|---|---|---|---|
| monomer (a) | 2-hydroxyethyl methacrylate | 12.80 | 13.00 | 12.60 | 12.60 | 12.60 |
| monomer (b) | methacrylic acid | 7.40 | 7.54 | 7.30 | 7.30 | 7.30 |
| monomer (d) | benzyl methacrylate | 6.65 | 6.70 | 6.50 | — | — |
| monomer (e) | phosphate methacrylate | 3.20 | 3.30 | 3.20 | 3.20 | 3.20 |
| monomer (h) | butyl diethyleneglycol | 6.00 | 6.11 | 5.90 | 5.90 | 5.90 |
| | methacrylate | | | | | |
| monomer (k) | trimethylcyclohexyl | 6.65 | 6.70 | 6.50 | 6.50 | 6.50 |
| | methacrylate | | | | | |
| monomer(m) | isobomyl methacrylate | 5.70 | 5.80 | 5.60 | 5.60 | 5.60 |
| stabilizer | mono t-butyl hydroquinone | 1.90 | 2.00 | 1.90 | 1.90 | 1.90 |
| | at 1% in butyl | | | | | |
| | diethyleneglycol | | | | | |
| | methacrylate | | | | | |
| curing catalyst | triphenyl phosphine at | — | — | 3.60 | 12.00 | 12.00 |
| | 40 ppc in benzyl | | | | | |
| | methacrylate | | | | | |
| curing catalyst | triphenyl phosphine | 1.90 | 2.00 | 1.90 | | |
| curative | N-(2-hydroxyethyl)-N- | 1.90 | 2.00 | 1.90 | 1.90 | 1.90 |
| | methyl-para-toluidine | | | | | |
| first constituent | phosphoric acid (85%) | 7.40 | 5.70 | 5.50 | 5.50 | 5.50 |
| of binary foaming | | | | | | |
| agent | | | | | | |
| toughener | methacrylate terminated | 10.90 | 11.00 | 10.60 | 10.60 | 10.60 |
| | butadiene-acrylonitrile | | | | | |
| | copolymer | | | | | |
| impact modifier | methyl methacrylate- | 27.60 | 28.15 | 27.00 | 27.00 | 27.00 |
| | butadiene-styrene | | | | | |
| | copolymer | | | | | |

| | | | | | |
|---|---|---|---|---|---|
| TOTAL | 100.00 | 100.00 | 100.00 | 100.00 | 100.00 |

Part B

| | | | | | | |
|---|---|---|---|---|---|---|
| polymerization | dibenzoyl peroxide, | 50.00 | 50.00 | 50.00 | 50.00 | 50.00 |
| initiator | low viscosity at 40% | | | | | |
| second constituent | calcium carbonate, | 50.00 | 50.00 | 50.00 | — | 50.00 |
| of binary | ultra fine | | | | | |
| foaming agent | | | | | | |
| second | calcium carbonate, average | — | — | — | 50.00 | — |
| constituent of | particle diameter 22 μm | | | | | |
| binary foaming | | | | | | |
| agent | | | | | | |

| | | | | | |
|---|---|---|---|---|---|
| TOTAL | 100.00 | 100.00 | 100.00 | 100.00 | 100.00 |
| Ratio Part A/Part B | 10/1 | 10/1 | 10/1 | 10/1 | 4/1 |
| Foam time (min) on bead | <2′ | >2′ | >2′ | 4′ | 2′ |
| Fixture time (min) on bead | 15′ | 14′ | 10′ | 12′ | <10′ |

The above data demonstrate that curable and foamable two-component acrylic adhesives can be prepared that spontaneously and autonomously cure and foam upon mixing the two components with one another. Foam time and fixture time can be specifically tailored and synchronized with one another in a manner such that the bubbles of gas (carbon dioxide) that are released from the binary chemical blowing agent (phosphoric acid and calcium carbonate) are captured by the curing acrylic material and form cells of a foam that becomes rigid.

1. An autonomously curable and foamable two-component acrylic adhesive of
(i) a first component comprising
a first constituent of a binary chemical foaming agent; and
a first curable ingredient which comprises or essentially consists of one or more acrylic monomers and/or one or more acrylate functionalized (pre-)polymers;
preferably one, two, three, four, five, six, seven or more acrylic monomers independently of one another selected from the group consisting of
monomers of formula (a) H₂C═CR—C(═O)—O-C₂₋₁₄-alkyl-OH;
monomers of formula (b) H₂C═CR—C(═O)—OH;
monomers of formula (c) H₂C═CR—C(═O)—O-C₂₋₁₈-alkyl;
monomers of formula (d) H₂C═CR—C(═O)—O-C₁₋₆-alkyl-(hetero-)aryl, wherein the (hetero-)aryl moiety is optionally substituted with one, two or three substituents independently of one another selected from -C₁₋₆-alkyl;
monomers of formula (e) H₂C═CR—C(═O)—O-C₂₋₁₄-alkyl-O—P(═O)(OH)₂;
monomers of formula (f) H₂C═CR—C(═O)—O-C₂₋₁₄-alkyl-O—C(═O)-C₁₋₆-alkyl-C(═O)-C₁₋₆-alkyl;
monomers of formula (g) H₂C═CR—C(═O)—[O—CH₂—CH₂]ₙ—OH, wherein index n is an integer within the range of from 1 to 12;
monomers of formula (h) H₂C═CR—C(═O)—[O—CH₂—CH₂]n-O-C₁₋₆-alkyl, wherein index n is an integer within the range of from 1 to 12;
monomers of formula (i) H₂C═CR—C(═O)—[O—CH₂—CH(CH₃)]ₙ—OH, wherein index n is an integer within the range of from 1 to 12;
monomers of formula (j) H₂C═CR—C(═O)—[O—CH₂—CH(CH₃)]ₙ—O-C₁₋₆-alkyl, wherein index n is an integer within the range of from 1 to 12;
monomers of formula (k) H₂C═CR—C(═O)—O-C₂-w(hetero-)cycloalkyl, wherein the (hetero-)cycloalkyl moiety is optionally substituted with one, two or three substituents independently of one another selected from -C₁₋₆-alkyl;
monomers of formula (l) H₂C═CR—C(=0)-0-C₁₋₆-alkyl-C₂₋₁₄-(hetero-cycloalkyl, wherein the (hetero-)cycloalkyl moiety is optionally substituted with one, two or three substituents independently of one another selected from -C₁₋₆-alkyl;
monomers of formula (m) H₂C═CR—C(═O)—O-C₇₋₁₄-bi- or tri-cycloalkyl, wherein the bi- or tri-cycloalkyl moiety is optionally substituted with one, two or three substituents independently of one another selected from -C₁₋₆-alkyl;
monomers of formula (n) H₂C═CR—C(=0)-0-C₁₋₆-alkyl-C₇₋₁₄-bi- or tri-cycloalkyl, wherein the bi- or tri-cycloalkyl moiety is optionally substituted with one, two or three substituents independently of one another selected from -C₁₋₆-alkyl;
monomers of formula (o) H₂C═CR—C(=0)-0-(hetero-)aryl, wherein the (hetero)aryl moiety is optionally substituted with one, two or three substituents independently of one another selected from -C₁₋₆-alkyl;
monomers of formula (p) H₂C═CR—C(=0)-0-C₂₋₁₄-alkyl-0-C(=0)-CR═CH₂;
monomers of formula (q) H₂C═CR—C(=0)-[0-CH₂—CH₂]ₙ-0-C(=0)-CR═CH₂;
wherein index n is an integer within the range of from 1 to 12;
monomers of formula (r) H₂C═CR—C(=0)-0-C₇₋₁₄-bi- or tri-cycloalkyl-0-C(=0)CR═CH₂, wherein the bi- or tri-cycloalkyl moiety is optionally substituted with one, two or three substituents independently of one another selected from -C1-6-alkyl;
monomers of formula(s) H₂C═CR—C(=0)-0-C₁₋₆-alkyl-C₇₋₁₄-bi- or tri-cycloalkyl-C₁₋₆-alkyl-0-C(=0)-CR═CH₂, wherein the bi- or tri-cycloalkyl moiety is optionally substituted with one, two or three substituents independently of one another selected from -C₁₋₆-alkyl; monomers of formula (t) H₂C═CR—C(=0)-[0-CHz-CH₂]n-0-phenyl-CR′R″-phenyl-0-[CHz-CH2-0]ₙ-C(=0)-CR═CH₂, wherein R′ and R″ independently of one another mean —H or -C₁₋₆-alkyl; wherein index n is an integer within the range of from 1 to 16; and
monomers of formula (u) [H₂C═CR—C(=0)-0-C₁₋₆-alkyl]₃-C₂₋₁₄-(hetero-)cycloalkyl, wherein the (hetero-)cycloalkyl moiety is optionally substituted with one, two or three substituents =0; wherein in each case R independently of one another means —H or —CH₃; and
(ii) a second component comprising
a second constituent of the binary chemical foaming agent which releases gas when being mixed with the first constituent of the binary chemical foaming agent;
optionally, a second curable ingredient which comprises or essentially consists of one or more acrylic monomers and/or one or more acrylate functionalized (pre-)polymers; preferably one, two, three, four, five, six, seven or more acrylic monomers independently of one another selected from the group consisting of monomers (a) to (u); and
a polymerization initiator;
wherein the first component and the second component are spatially separated from one another; and
wherein mixing the first component and the second component with one another induces the formation of a cured foamed acrylic adhesive.

2. The two-component acrylic adhesive according to claim 1, wherein the first constituent or the second constituent of the binary chemical foaming agent comprises or essentially consists of an acid, and wherein the other of the first constituent and the second constituent comprises or essentially consists of a metal carbonate or metal hydrogencarbonate.

3. The two-component acrylic adhesive according to claim 2, wherein the first constituent comprises or essentially consists of the acid, and wherein the second constituent comprises or essentially consists of the metal carbonate or metal hydrogencarbonate.

4. The two-component acrylic adhesive according to claim 2 or 3, wherein the metal carbonate or metal hydrogencarbonate is selected from the group consisting of calcium carbonate, magnesium carbonate, zinc carbonate, sodium carbonate, sodium hydrogencarbonate, potassium carbonate, potassium hydrogencarbonate, and mixtures thereof; preferably calcium carbonate.

5. The two-component acrylic adhesive according to any of claim 2 to 4, wherein the acid is a mineral acid; preferably selected from the group consisting of sulfuric acid, phosphoric acid, and mixtures thereof; preferably phosphoric acid.

6. The two-component acrylic adhesive of claim 1, wherein the first constituent of the binary chemical foaming agent has a content of
at least 1.5 wt.-%, preferably at least 2.0 wt.-%, more preferably at least 2.5 wt.-%, still more preferably at least 3.0 wt.-%, yet more preferably at least 3.5 wt.-%, even more preferably at least 4.0 wt.-%, most preferably at least 4.5 wt.-%, and in particular at least 5.0 wt.-%; and/or
at most 25 wt.-%, preferably at most 22.5 wt.-%, more preferably at most 20 wt.-%, still more preferably at most 17.5 wt.-%, yet more preferably at most 15 wt.-%, even more preferably at most 12.5 wt.-%, most preferably at most 10 wt.-%, and in particular at most 7.5 wt.-%; in each case relative to the total weight of the first component.

7. The two-component acrylic adhesive of claim 1, wherein the second constituent of the binary chemical foaming agent has a content of
at least 10 wt.-%, preferably at least 15 wt.-%, more preferably at least 20 wt.-%, still more preferably at least 25 wt.-%, yet more preferably at least 30 wt.-%, even more preferably at least 35 wt.-%, most preferably at least 40 wt.-%, and in particular at least 45 wt.-%; and/or
at most 90 wt.-%, preferably at most 85 wt.-%, more preferably at most 80 wt.-%, still more preferably at most 75 wt.-%, yet more preferably at most 70 wt.-%, even more preferably at most 65 wt.-%, most preferably at most 60 wt.-%, and in particular at most 55 wt.-%; in each case relative to the total weight of the second component.

8.-82. (canceled)

83. The two-component acrylic adhesive according to claim 1, wherein the first component and/or the second component additionally comprise at least one, preferably at least two, more preferably at least three and most preferably all four of
a first toughening agent;
a second toughening agent differing from the first toughening agent;
a first impact modifier; and
a second impact modifier differing from the first impact modifier.

84. The two-component acrylic adhesive according to claim 1, wherein the first toughening agent is a liquid toughening agent; preferably selected from the group consisting of aliphatic and aromatic urethane (meth)acrylate, epoxy (meth)acrylate, polyester (meth)acrylate and (meth)acrylate terminated butadiene-acrylonitrile copolymer.

85.-109. (canceled)

110. A method of bonding two substrates comprising the steps of
(a) mixing the first component as defined in any of the preceding clauses and the second component as defined in any of the preceding clauses with one another thereby providing a combined first component and the second component;
(b) applying the combined first component and the second component obtained in step (a) to a first substrate and/or a second substrate;
(c) optionally, allowing time to elapse prior to expiry of the open time, e.g. for performing some other action;
(d) adhering the first substrate and the second substrate to one another; and
(e) allowing the combined first component and the second component to cure thereby providing a cured acrylic adhesive.
